(19) United States
(12) Patent Application Publication
(10) Pub. No.: US 2026/0058766 A1
(43) Pub. Date: Feb. 26, 2026

(54) METHOD FOR SENDING/RECEIVING PHASE FACTOR AND AMPLITUDE FACTOR OF TRP OR TRP GROUP, AND APPARATUS THEREFOR

(71) Applicant: BEIJING XIAOMI MOBILE SOFTWARE CO., LTD., Beijing (CN)

(72) Inventor: Xueyuan GAO, Beijing (CN)

(73) Assignee: BEIJING XIAOMI MOBILE SOFTWARE CO., LTD., Beijing (CN)

(21) Appl. No.: 18/992,267

(22) PCT Filed: Jul. 18, 2022
(86) PCT No.: PCT/CN2022/106341

§ 371 Date: Jan. 8, 2025

(51) Int. Cl. H04L 5/00; H04B 7/0456

(52) U.S. Cl. CPC H04L 5/0035; H04B 7/0456

(57) ABSTRACT

A method for sending a phase factor and an amplitude factor of a transmission reception point (TRP) or TRP group includes: sending at least one factor of the phase factor or the amplitude factor of the TRP or TRP group to a network device based on a combining coefficient matrix of the TRP or TRP group, in which, the TRP group includes at least one TRP.

### CROSS-REFERENCE TO RELATED APPLICATIONS

This application is a U.S. National Phase of International Application No. PCT/CN2022/106341, filed Jul. 18, 2022, the entire content of which is incorporated herein by reference.

### TECHNICAL FIELD

The disclosure relates to a field of communication technology, in particular to a method for sending/receiving a phase factor and an amplitude factor of a transmission reception point (TRP) or TRP group and a device thereof.

### BACKGROUND

Coordinated multiple points transmission/reception refers to multi transmission reception points (mTRPs)/multi panels providing data services for one user. In a multi-TPR scenario, a base station needs to know an amplitude factor αₙ and/or a phase factor ρₙ of a TRP or TRP group in a case of determining downlink transmission precoding of a terminal device based on a codebook.

### SUMMARY

In a first aspect, embodiments of the present disclosure provide a method for sending a phase factor and an amplitude factor of a TRP or TRP group. The method includes:
sending at least one factor of the phase factor or the amplitude factor of the TRP or TRP group to a network device based on a combining coefficient matrix of the TRP or TRP group, in which the TRP group includes at least one TRP.

In a second aspect, embodiments of the present disclosure provide a method for receiving a phase factor and an amplitude factor of a TRP or TRP group. The method includes:
receiving at least one factor of the phase factor or the amplitude factor of the TRP or TRP group that is sent by a terminal device based on a combining coefficient matrix of the TRP or TRP group, in which, the TRP group includes at least one TRP.

In a third aspect, an embodiment of the present disclosure provides a terminal device. The terminal device includes a processor and a memory having a computer program stored thereon. The processor is configured to send at least one factor of the phase factor or the amplitude factor of the TRP or TRP group to a network device based on a combining coefficient matrix of the TRP or TRP group, in which the TRP group includes at least one TRP.

### BRIEF DESCRIPTION OF THE DRAWINGS

In order to clearly illustrate technical solutions of embodiments of the disclosure or background, the accompanying drawings required in embodiments of the present disclosure or the background will be explained below.

FIG. 1 is a schematic diagram illustrating coordinated multiple points transmission/reception provided in an embodiment of the present disclosure.

FIG. 1a is a schematic diagram illustrating an architecture of a communication system provided in an embodiment of the present disclosure.

FIG. 2 is a flowchart illustrating a method for sending a phase factor and an amplitude factor of a TRP or TRP group according to an embodiment of the present disclosure.

FIG. 3 is a flowchart illustrating another method for sending a phase factor and an amplitude factor of a TRP or TRP group according to another embodiment of the present disclosure.

FIG. 4 is a flowchart illustrating another method for sending a phase factor and an amplitude factor of a TRP or TRP group according to another embodiment of the present disclosure.

FIG. 5 is a flowchart illustrating another method for sending a phase factor and an amplitude factor of a TRP or TRP group according to another embodiment of the present disclosure.

FIG. 6 is a flowchart illustrating another method for sending a phase factor and an amplitude factor of a TRP or TRP group according to another embodiment of the present disclosure.

FIG. 7 is a flowchart illustrating another method for sending a phase factor and an amplitude factor of a TRP or TRP group according to another embodiment of the present disclosure.

FIG. 8 is a flowchart illustrating another method for sending a phase factor and an amplitude factor of a TRP or TRP group according to another embodiment of the present disclosure.

FIG. 9 is a flowchart illustrating another method for sending a phase factor and an amplitude factor of a TRP or TRP group according to another embodiment of the present disclosure.

FIG. 10 is a flowchart illustrating a method for receiving a phase factor and an amplitude factor of a TRP or TRP group according to another embodiment of the present disclosure.

FIG. 11 is a flowchart illustrating another method for receiving a phase factor and an amplitude factor of a TRP or TRP group according to another embodiment of the present disclosure.

FIG. 12 is a flowchart illustrating another method for receiving a phase factor and an amplitude factor of a TRP or TRP group according to another embodiment of the present disclosure.

FIG. 13 is a flowchart illustrating another method for receiving a phase factor and an amplitude factor of a TRP or TRP group according to another embodiment of the present disclosure.

FIG. 14 is a flowchart illustrating another method for receiving a phase factor and an amplitude factor of a TRP or TRP group according to another embodiment of the present disclosure.

FIG. 15 is a flowchart illustrating another method for receiving a phase factor and an amplitude factor of a TRP or TRP group according to another embodiment of the present disclosure.

FIG. 16 is a flowchart illustrating another method for receiving a phase factor and an amplitude factor of a TRP or TRP group according to another embodiment of the present disclosure.

FIG. 17 is a block diagram illustrating a structure of a communication apparatus according to an embodiment of the present disclosure.

FIG. 18 is a block diagram illustrating a structure of another communication apparatus according to another embodiment of the present disclosure.

FIG. 19 is a block diagram illustrating a structure of a chip according to an embodiment of the present disclosure.

### DETAILED DESCRIPTION

Embodiments will be described in detail herein, examples of which are illustrated in the accompanying drawings. The following description refers to the accompanying drawings in which the same numbers in different drawings represent the same or similar elements unless otherwise represented. The implementations set forth in the following description of embodiments do not represent all implementations consistent with embodiments of the disclosure. Instead, they are merely examples of apparatuses and methods consistent with aspects related to the disclosure as recited in the appended claims.

The terms used in embodiments of the present disclosure are only for the purpose of describing specific embodiments, and are not intended to limit embodiments of the present disclosure. The singular forms “a” and “the” used in embodiments of the present disclosure and the appended claims are also intended to include plural forms unless the context clearly indicates otherwise. It is also understood that the term “and/or” as used herein refers to and includes any and all possible combinations of one or more of associated listed items.

It should be understood that, although the terms first, second, third, etc. may be used in embodiments of the present disclosure to describe various information, such information shall not be limited to these terms. These terms are only used to distinguish the same category of information. For example, subject to the scope of embodiments of the present disclosure, first information may also be referred to as second information, and similarly, second information may also be referred to as first information. It depends on the context. For example, the word “if” as used herein may be interpreted as “upon” or “when” or “in response to determining”. For the purposes of brevity and ease of understanding, the disclosure uses the terms “greater than” or “less than”, “higher than” or “lower than” herein in a case of characterizing a size relationship. Those skilled in the art may understand that: the term “greater than” also covers the meaning of “greater than or equal to”, and the term “less than” also covers the meaning of “less than or equal to”; the term “higher than” covers the meaning of “higher than or equal to”, the term “less than” also covers the meaning of “less than or equal to”.

To facilitate understanding, terms involved in the disclosure are introduced first.

Coordinated multiple points transmission/reception technology may be classified into two types of coherent joint transmission (CJT) and in-coherent joint transmission (NCJT). The so-called CJT means that each data flow will may be mapped to an m-TRP/Panel participating in collaboration through a weighted vector. The CJT is equivalent to splicing multiple sub-arrays into a higher-dimensional virtual array to obtain higher beamforming or precoding gains.

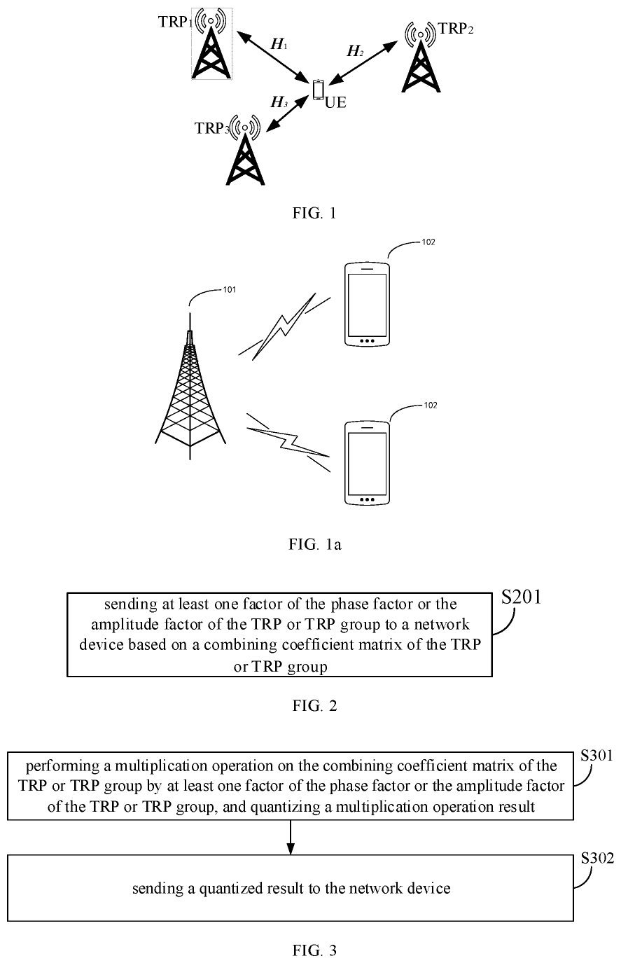

FIG. 1 shows a scenario where three TRPs serve a UE through CJT. Channels from the UE to respective TRPs are represented as H₁, H₂ and H₃, respectively. Calculating precoding for the UE may include combining these channels into a higher-dimensional channel, namely

$$H = {[ {H}_{1}^{T} , {H}_{2}^{T} , {H}_{3}^{T} ]}^{T} ,$$

and then calculating downlink data transmission precoding for the UE based on H.

During multiple TRPs perform the CJT, the following optional codebook structure may be used to calculate the downlink data transmission precoding for the user.

$$Alt 1 A : [ \begin{matrix}( {a}_{1} {p}_{1} ) \times {W}_{1 , 1} {\tilde{W}}_{2 , 1} {W}_{f , 1}^{H} \\ ⋮ \\ ( {a}_{N} {p}_{N} ) \times {W}_{1 , N} {\tilde{W}}_{2 , N} {W}_{f , N}^{H}\end{matrix} ]$$

$$Alt 1 B : [ \begin{matrix}( {a}_{1} {p}_{1} ) \times {W}_{SF , 1} {\tilde{W}}_{2 , 1} \\ ⋮ \\ ( {a}_{N} {p}_{N} ) \times {W}_{SF , N} {\tilde{W}}_{2 , N}\end{matrix} ]$$

$$Alt 2 : [ \begin{matrix}{W}_{1 , 1} & 0 & 0 & 0 \\ 0 & ⋱ & 0 & 0 \\ 0 & 0 & & \\ 0 & 0 & & {W}_{1 , N}\end{matrix} ] {\tilde{W}}_{2} {W}_{f}^{H}$$

where αₙ and ρₙ denote a phase factor and an amplitude factor corresponding to the n-th TRP respectively, W_{1,n} denotes a time domain (SD) basis vector corresponding to the n-th TRP, \tilde{W}_{2,n} denotes a combining coefficient corresponding to the n-th TRP, W_{ƒ,n} denotes a frequency domain (FD) basis vector corresponding to the n-th TRP, W_{SF,n} denotes a combination of the SD basis vector and the FD basis vector corresponding to the n-th TRP, \tilde{W}₂ denotes combining coefficients corresponding to N TRPs, W_{ƒ} denotes FD basis vectors corresponding to N TRPs.

For the combining coefficients \tilde{W}₂ in the Rel-16/17 Type II codebook structure, quantizing \tilde{W}₂ adopts a differential method in a polarization direction, to improve a quantizing accuracy of the combining coefficients. That is, each coefficient in the combining coefficients may be expressed as a product of two elements, as shown in the following formula:

$${\tilde{W}}_{2} = [ \begin{matrix}{r}_{0} {c}_{1 , 1}^{0} & ⋯ & {r}_{0} {c}_{1 , M}^{0} \\ ⋮ & ⋱ & ⋮ \\ {r}_{0} {c}_{L , 1}^{0} & ⋯ & {r}_{0} {c}_{L , M}^{0} \\ {r}_{1} {c}_{L + 1 , 1}^{1} & ⋯ & {r}_{1} {c}_{L + 1 , M}^{1} \\ ⋮ & ⋱ & ⋮ \\ {r}_{1} {c}_{2 L , 1}^{1} & ⋯ & {r}_{1} {c}_{2 L , M}^{1}\end{matrix} ]$$

where r₀ and r₁ denote reference amplitudes in a first polarization direction and a second polarization direction respectively,

$${c}_{l , m}^{p}$$

denotes a differential coefficient on the 1-th row and m-th column in the p-th polarization direction in the combining coefficient matrix \tilde{W}₂, and the differential coefficient may be represented by the corresponding differential amplitude and differential phase.

In order to better understand a method for sending/receiving a phase factor and an amplitude factor of a TRP or TRP group proposed in an embodiment of the present disclosure, a communication system for which the embodiment of the present disclosure is applied is first described below.

Please refer to FIG. 1a, FIG. 1a is a structural diagram of a communication system provided by an embodiment of the disclosure. The communication system may include, but is not limited to, one network device and one terminal device. The number and the form of devices illustrated in FIG. 1a are only for examples and do not constitute a limitation on the embodiments of the disclosure. The communication system may include two or more network devices and two or more terminal devices in practical applications. The communication system illustrated in FIG. 1a includes, for example, a network device 101 and a terminal device 102.

It is noteworthy that the technical solutions of the embodiments of the disclosure may be applied to various communication systems, such as, a long term evolution (LTE) system, a 5th generation (5G) mobile communication system, a 5G NR (new radio) system, or other future new mobile communication systems. It should also be noted that a sidelink in an embodiment of the present disclosure may also be called as a side link or a direct link.

The network device 101 in embodiments of the disclosure is an entity on a network side for transmitting or receiving signals. For example, the network device 101 may be an evolved NodeB (eNB), a transmission reception point (TRP), a next generation NodeB (gNB) in a NR system, a base station in other future mobile communication systems, or an access node in a wireless fidelity (WiFi) system. The specific technology and specific device form adopted by the network device are not limited in the embodiments of the disclosure. The network device according to the embodiments of the disclosure may be composed of a central unit (CU) and distributed units (DUs). The CU may also be referred to as a control unit. The use of CU-DU structure allows to divide a protocol layer of the network device, such as a base station, such that some of the protocol layer functions are placed in the CU for centralized control, and some or all of the remaining protocol layer functions are distributed in the DUs, and the DUs are centrally controlled by the CU.

The terminal device 102 in embodiments of the disclosure is an entity on a user side for receiving or transmitting signals, such as a cellular phone. The terminal device may also be referred to as a terminal, a user equipment (UE), a mobile station (MS), a mobile terminal (MT), and the like. The terminal device can be a car with communication functions, a smart car, a mobile phone, a wearable device, a Pad, a computer with wireless transceiver functions, a virtual reality (VR) terminal device, an augmented reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. The specific technology and specific device form adopted by the terminal device are not limited in the embodiments of the disclosure.

In sidelink communication, there are 4 sidelink transmission modes. Sidelink transmission mode 1 and sidelink transmission mode 2 are used for terminal device direct (device-to-device, D2D) communication. Sidelink transmission mode 3 and sidelink transmission mode 4 are used for V2X communications. When the sidelink transmission mode 3 is adopted, resource allocation is scheduled by the network device 101. Specifically, the network device 101 may send resource allocation information to the terminal device 102, and then the terminal device 102 allocates resources to another terminal device, so that another terminal device may send information to the network device 101 through the allocated resources. In the V2X communication, a terminal device with better signal or higher reliability may be used as the terminal device 102. A first terminal device mentioned in an embodiment of the present disclosure may refer to the terminal device 102, and a second terminal device may refer to another terminal device.

It is understandable that the communication system described in embodiments of the disclosure is intended to clearly illustrate the technical solutions according to the embodiments of the disclosure, and does not constitute a limitation on the technical solutions according to the embodiments of the disclosure. It is understandable by those skilled in the art that as system architectures evolve and new business scenarios emerge, the technical solutions according to the embodiments of the disclosure are also applicable to similar technical problems.

It should be noted that a method for sending/receiving a phase factor and an amplitude factor of a TRP or TRP group provided by any embodiment of the present disclosure may be executed alone, or may be executed in combination with possible implementation methods in other embodiments, or may be executed in combination with any technical solution in related arts.

A method for sending/receiving a phase factor and an amplitude factor of a TRP or TRP group and a device thereof provided by the present disclosure will be introduced in detail below with reference to the accompanying drawings.

Please refer to FIG. 2, FIG. 2 is a flowchart illustrating a method for sending a phase factor and an amplitude factor of a TRP or TRP group according to an embodiment of the present disclosure. The method for sending a phase factor and an amplitude factor is performed by a terminal device. As illustrated in FIG. 2, the method may include, but is not limited to, a following step.

At step 201, at least one factor of the phase factor or the amplitude factor of the TRP or TRP group is sent to a network device based on a combining coefficient matrix of the TRP or TRP group.

The TRP group includes at least one TRP.

The terminal device may correspond to one or more TRP groups. It is required to report the phase factor and the amplitude factor of each TRP or TRP group to the network device, so that the network device may determine downlink transmission precoding of the terminal device based on a codebook and the amplitude factor and phase factor of the TPR group.

Optionally, the terminal device may implicitly report the phase factor and/or the amplitude factor corresponding to the TRP or TPR group to the network device. In some implementations, at least one factor of the phase factor or the amplitude factor of the TRP or TRP group is sent to the network device based on the combining coefficient matrix of the TRP or TRP group. That is, at least one factor of the phase factor and the amplitude factor of the TRP or TRP group is incorporated into the combining coefficient matrix of the TRP or TRP group, and is sent to the network device through the combining coefficient matrix of the TRP or TRP group. It should be noted that one TRP group corresponds to one combining coefficient matrix, that is, each TRP or TRP group corresponds to its own combining coefficient matrix. Optionally, the terminal device may incorporate at least one of the phase factor and amplitude factor of the TRP or TRP group into the combining coefficient matrix of the TRP or TRP group, and may send at least one of the phase factor and amplitude factor to the network device in a wideband (WB) manner and/or in a sub-band (SB) manner.

In an implementation, the terminal device may incorporate a first factor in the phase factor and the amplitude factor of the TRP or TRP group into the combining coefficient matrix of the TRP or TRP group, and may send the first factor to the network device in the wideband manner or in the sub-band manner. Further, the terminal device may send a second factor in the phase factor and the amplitude factor of the TRP or TRP group into the combining coefficient matrix of the TRP or TRP group, and may send the second factor to the network device in the wideband manner or in the sub-band manner. For example, the second factor may be sent to the network device separately in the wideband manner or in the sub-band manner. For another example, the second factor may be combined with other parameters, and a combined result is sent to the network device in the wideband manner or in the sub-band manner. The first factor may be the phase factor and the second factor may be the amplitude factor; or the first factor may be the amplitude factor and the second factor may be the phase factor.

In another implementation, the terminal device may incorporate the phase factor and the amplitude factor of the TRP or TRP group into the combining coefficient matrix of the TRP or TRP group. Further, the terminal device may send the combining coefficient matrix to the network device in the wideband manner or in the sub-band manner.

In an embodiment of the present disclosure, at least one factor of the phase factor or the amplitude factor of the TRP or TRP group is sent to the network device based on the combining coefficient matrix of the TRP or TRP group. At least one factor of the phase factor or the amplitude factor of the TRP or TRP group may be incorporated into the combining coefficient matrix of the TRP or TRP group and is sent to the network device, which may reduce a signaling overhead occupied when a terminal device directly feeds back the phase factor and amplitude factor to the network device. Furthermore, the present disclosure may cause the network device to understand a TRP status of the terminal device, and then determine downlink transmission precoding.

Please refer to FIG. 3, FIG. 3 is a flowchart illustrating a method for sending a phase factor and an amplitude factor of a TRP or TRP group according to an embodiment of the present disclosure. The method for sending a phase factor and an amplitude factor of a TRP or TRP group is performed by a terminal device. As illustrated in FIG. 3, the method may include, but is not limited to, following steps.

At step 301, a multiplication operation is performed on the combining coefficient matrix of the TRP or TRP group by at least one factor of the phase factor or the amplitude factor of the TRP or TRP group, and a multiplication operation result is quantized.

Optionally, the multiplication operation is performed on the combining coefficient matrix by the phase factor and the amplitude factor and a multiplication operation result is quantized.

Optionally, the multiplication operation is performed on the combining coefficient matrix by the phase factor and a multiplication operation result is quantized. Furthermore, the amplitude factor may be quantized independently.

Optionally, the multiplication operation is performed on the combining coefficient matrix by the amplitude factor and a multiplication operation result is quantized. Furthermore, the phase factor may be quantized independently.

Optionally, the multiplication operation is performed on the combining coefficient matrix by a first factor in the phase factor and the amplitude factor and a wideband factor part of a second factor in the phase factor and the amplitude factor, and a multiplication operation result is quantized. Furthermore, a sub-band factor part of the second factor may be independently quantized. For example, the first factor is the amplitude factor and the second factor is the phase factor, the phase factor includes a wideband phase factor and a sub-band phase factor. A multiplication operation may be performed on the combining coefficient matrix by the amplitude factor and the wideband phase factor and a multiplication operation result is quantized, and the sub-band phase factor is independently quantized. For another example, the first factor is the phase factor and the second factor is the amplitude factor, the amplitude factor comprises a wideband amplitude factor and a sub-band amplitude factor. A multiplication operation may be performed on the combining coefficient matrix by the phase factor and the wideband amplitude factor and a multiplication operation result may be quantized, and the sub-band amplitude factor may be independently quantized.

Optionally, a multiplication operation may be performed on the combining coefficient matrix by the sub-band factor part of the phase factor and the amplitude factor, and a multiplication operation result may be quantized, the wideband factor part of the phase factor and the amplitude factor may be independently quantized. It should be noted that the combining coefficient matrix may be a sub-band combining coefficient matrix.

At step S302, a quantized result is sent to the network device.

Optionally, the quantized result may be sent to the network device in the wideband manner and/or the sub-band manner.

Optionally, quantized results corresponding may be sent to the phase factor and the amplitude factor respectively to the network device in the wideband manner. For example, the quantized result obtained by multiplying and quantizing the phase factor and the amplitude factor with the combining coefficient matrix may be sent to the network device in the wideband manner.

Optionally, a quantized result corresponding to a first factor in the phase factor and the amplitude factor is sent to the network device in the wideband manner. Furthermore, a quantized result corresponding to a second factor in the phase factor and the amplitude factor is sent to the network device in the sub-band manner. For example, the quantized result obtained by performing the multiplication operation on the combining coefficient matrix by the phase factor and quantizing the multiplication operation result may be sent to the network device in the wideband manner, and the quantized result or an independent quantized result obtained by performing the multiplication operation on the combining coefficient matrix by the amplitude factor may be sent to the network device in the sub-band manner. For another example, the quantized result obtained by performing the multiplication operation on the combining coefficient matrix by the phase factor and the wideband amplitude factor and quantizing the multiplication operation result, may be sent to the network device in the wideband manner, and the quantized result of the sub-band amplitude factor may be sent to the network device in the sub-band manner. For another example, the quantized result obtained by performing the multiplication operation on the combining coefficient matrix by the amplitude factor and the wideband phase factor and quantizing the multiplication operation result, may be sent to the network device in the wideband manner, and the quantized result of the sub-band phase factor may be sent to the network device in the sub-band manner. For another example, the phase factor includes the sub-band phase factor and the wideband phase factor, and the amplitude factor includes the sub-band amplitude factor and the wideband amplitude factor. In an embodiment of the present disclosure, a multiplication operation is performed on the combining coefficient matrix by the sub-band phase factor and the sub-band amplitude factor, and a multiplication operation result is quantized, and the quantized result is sent to the network device in the sub-band manner. Further, the independent quantized results of the wideband phase factor and the wideband amplitude factor may be sent to the network device in the wideband manner.

Optionally, quantized results corresponding to the phase factor and the amplitude factor respectively are sent to the network device in the sub-band manner. For example, the quantized results obtained by performing a multiplication operation on the combining coefficient matrix by the phase factor and the amplitude factor respectively, may be sent to the network device in the sub-band manner. For another example, the quantized results obtained by performing a multiplication operation on the sub-band combining coefficient matrix by the sub-band phase factor and the sub-band amplitude factor respectively, may be sent to the network device in the sub-band manner.

In an embodiment of the present disclosure, at least one factor of the phase factor or the amplitude factor of the TRP or TRP group is sent to the network device based on the combining coefficient matrix of the TRP or TRP group. At least one factor of the phase factor or the amplitude factor of the TRP or TRP group may be incorporated into the combining coefficient matrix of the TRP or TRP group and is sent to the network device, which may reduce a signaling overhead occupied when a terminal device directly feeds back the phase factor and amplitude factor to the network device. Furthermore, the present disclosure may cause the network device to understand a TRP status of the terminal device, and then determine downlink transmission precoding.

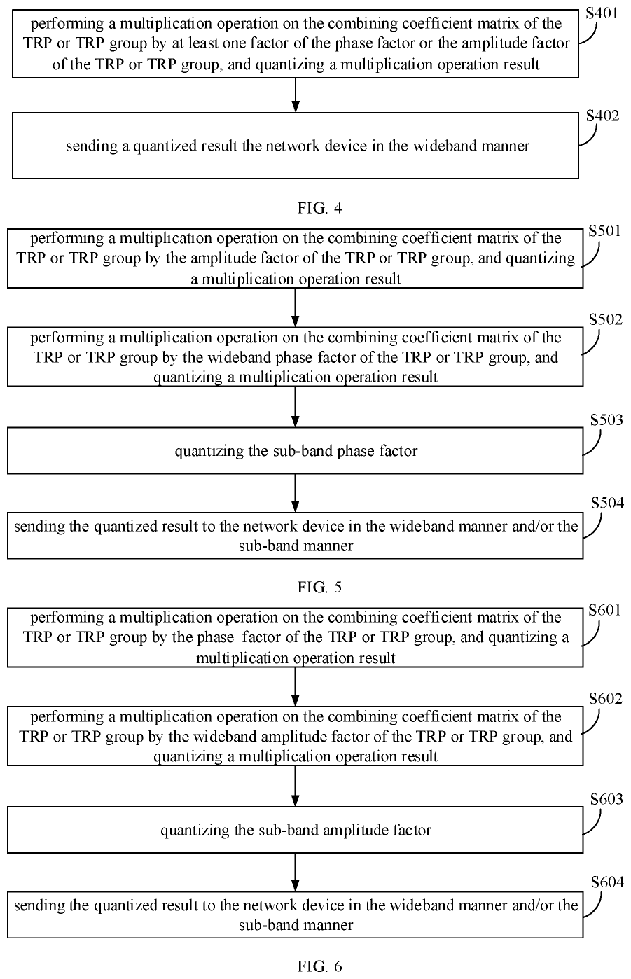

Please refer to FIG. 4, FIG. 4 is a flowchart illustrating a method for sending a phase factor and an amplitude factor of a TRP or TRP group according to an embodiment of the present disclosure. The method for sending a phase factor and an amplitude factor is performed by a terminal device. As illustrated in FIG. 4, the method may include, but is not limited to, following steps.

At step S401, a multiplication operation is performed on the combining coefficient matrix of the TRP or TRP group by at least one factor of the phase factor or the amplitude factor of the TRP or TRP group, and a multiplication operation result is quantized.

As a possible implementation, a product of the phase factor and the amplitude factor is determined, and a multiplication operation is performed on combining coefficients in the combining coefficient matrix by the product, and a multiplication operation result is quantized.

In an embodiment of the present disclosure, the phase factor and the amplitude factor are multiplied with \tilde{W}_{2,n} to obtain [symbol] and [symbol] is quantized. The amplitude and the phase of each coefficient in [symbol] are quantized separately, or [symbol] is quantized by using a Type II codebook in the existing protocol via differential means in a polarization direction for the combining coefficients \tilde{W}₂.

As an example, two TRPs, namely a first TRP and a second TRP, serve an edge UE through CJT. The UE obtains respective combining coefficient matrixes corresponding to the two TRPs based on a calculation method of the existing Type II codebook based on downlink channels from the two TRPs to the UE. The combining coefficient matrixes are provided as follows:

$${\tilde{W}}_{2 , 1} = [ \begin{matrix}{r}_{0 , 1} {c}_{1 , 1}^{0 , 1} & ⋯ & {r}_{0 , 1} {c}_{1 , M}^{0 , 1} \\ ⋮ & ⋱ & ⋮ \\ {r}_{0 , 1} {c}_{L , 1}^{0} & ⋯ & {r}_{0 , 1} {c}_{L , M}^{0} \\ {r}_{1 , 1} {c}_{L + 1 , 1}^{1} & ⋯ & {r}_{1 , 1} {c}_{L + 1 , M}^{1} \\ ⋮ & ⋱ & ⋮ \\ {r}_{1 , 1} {c}_{2 L , 1}^{1} & ⋯ & {r}_{1 , 1} {c}_{2 L , M}^{1}\end{matrix} ] , {\tilde{W}}_{2 , 2} = [ \begin{matrix}{r}_{0 , 2} {c}_{1 , 1}^{0 , 2} & ⋯ & {r}_{0 , 2} {c}_{1 , M}^{0 , 2} \\ ⋮ & ⋱ & ⋮ \\ {r}_{0 , 2} {c}_{L , 1}^{0 , 2} & ⋯ & {r}_{0 , 2} {c}_{L , M}^{0 , 2} \\ {r}_{1 , 2} {c}_{L + 1 , 1}^{1 , 2} & ⋯ & {r}_{1 , 2} {c}_{L + 1 , M}^{1 , 2} \\ ⋮ & ⋱ & ⋮ \\ {r}_{1 , 2} {c}_{2 L , 1}^{1 , 2} & ⋯ & {r}_{1 , 2} {c}_{2 L , M}^{1 , 2}\end{matrix} ]$$

It should be noted that the first TRP and the second TRP are two independent TRPs, and the first TRP and the second TRP do not belong to one TRP group.

For example, the phase factor and the amplitude factor corresponding to the first TRP areρ₁, α₁, respectively, and the phase factor and the amplitude factor corresponding to the second TRP are ρ₂, α₂, respectively.

Optionally, the multiplication operation is performed on the combining coefficient matrix by the phase factor and the amplitude factor, which is provided as follows:

$$= {a}_{1} {p}_{1} [ \begin{matrix}{r}_{0 , 1} {c}_{1 , 1}^{0 , 1} & ⋯ & {r}_{0 , 1} {c}_{1 , M}^{0 , 1} \\ ⋮ & ⋱ & ⋮ \\ {r}_{0 , 1} {c}_{L , 1}^{0} & ⋯ & {r}_{0 , 1} {c}_{L , M}^{0} \\ {r}_{1 , 1} {c}_{L + 1 , 1}^{1} & ⋯ & {r}_{1 , 1} {c}_{L + 1 , M}^{1} \\ ⋮ & ⋱ & ⋮ \\ {r}_{1 , 1} {c}_{2 L , 1}^{1} & ⋯ & {r}_{1 , 1} {c}_{2 L , M}^{1}\end{matrix} ] = [ \begin{matrix}{a}_{1} {p}_{1} {r}_{0 , 1} {c}_{1 , 1}^{0 , 1} & ⋯ & {a}_{1} {p}_{1} {r}_{0 , 1} {c}_{1 , M}^{0 , 1} \\ ⋮ & ⋱ & ⋮ \\ {a}_{1} {p}_{1} {r}_{0 , 1} {c}_{L , 1}^{0} & ⋯ & {a}_{1} {p}_{1} {r}_{0 , 1} {c}_{L , M}^{0} \\ {a}_{1} {p}_{1} {r}_{1 , 1} {c}_{L + 1 , 1}^{1} & ⋯ & {a}_{1} {p}_{1} {r}_{1 , 1} {c}_{L + 1 , M}^{1} \\ ⋮ & ⋱ & ⋮ \\ {a}_{1} {p}_{1} {r}_{1 , 1} {c}_{2 L , 1}^{1} & ⋯ & {a}_{1} {p}_{1} {r}_{1 , 1} {c}_{2 L , M}^{1}\end{matrix} ] ;$$

$$= {a}_{2} {p}_{2} [ \begin{matrix}{r}_{0 , 2} {c}_{1 , 1}^{0 , 2} & ⋯ & {r}_{0 , 2} {c}_{1 , M}^{0 , 2} \\ ⋮ & ⋱ & ⋮ \\ {r}_{0 , 2} {c}_{L , 1}^{0 , 2} & ⋯ & {r}_{0 , 2} {c}_{L , M}^{0 , 2} \\ {r}_{1 , 2} {c}_{L + 1 , 1}^{1 , 2} & ⋯ & {r}_{1 , 2} {c}_{L + 1 , M}^{1 , 2} \\ ⋮ & ⋱ & ⋮ \\ {r}_{1 , 2} {c}_{2 L , 1}^{1 , 2} & ⋯ & {r}_{1 , 2} {c}_{2 L , M}^{1 , 2}\end{matrix} ] = [ \begin{matrix}{a}_{2} {p}_{2} {r}_{0 , 2} {c}_{1 , 1}^{0 , 2} & ⋯ & {a}_{2} {p}_{2} {r}_{0 , 2} {c}_{1 , M}^{0 , 2} \\ ⋮ & ⋱ & ⋮ \\ {a}_{2} {p}_{2} {r}_{0 , 2} {c}_{L , 1}^{0 , 2} & ⋯ & {a}_{2} {p}_{2} {r}_{0 , 2} {c}_{L , M}^{0 , 2} \\ {a}_{2} {p}_{2} {r}_{1 , 2} {c}_{L + 1 , 1}^{1 , 2} & ⋯ & {a}_{2} {p}_{2} {r}_{1 , 2} {c}_{L + 1 , M}^{1 , 2} \\ ⋮ & ⋱ & ⋮ \\ {a}_{2} {p}_{2} {r}_{1 , 2} {c}_{2 L , 1}^{1 , 2} & ⋯ & {a}_{2} {p}_{2} {r}_{1 , 2} {c}_{2 L , M}^{1 , 2}\end{matrix} ] ;$$

The amplitude and the phase corresponding to each coefficient in [symbol] and [symbol] obtained after the multiplication operation are quantized by a bits and b bits respectively.

Optionally, mathematical transformation is made on the above [symbol] and [symbol] to obtain the following formulation:

$$= [ \begin{matrix}{s}_{0 , 1} {d}_{1 , 1}^{0 , 1} & ⋯ & {s}_{0 , 1} {d}_{1 , M}^{0 , 1} \\ ⋮ & ⋱ & ⋮ \\ {s}_{0 , 1} {d}_{L , 1}^{0} & ⋯ & {s}_{0 , 1} {d}_{L , M}^{0} \\ {s}_{1 , 1} {d}_{L + 1 , 1}^{1} & ⋯ & {s}_{1 , 1} {d}_{L + 1 , M}^{1} \\ ⋮ & ⋱ & ⋮ \\ {s}_{1 , 1} {d}_{2 L , 1}^{1} & ⋯ & {s}_{1 , 1} {d}_{2 L , M}^{1}\end{matrix} ] , = [ \begin{matrix}{s}_{0 , 2} {d}_{1 , 1}^{0 , 2} & ⋯ & {s}_{0 , 2} {d}_{1 , M}^{0 , 2} \\ ⋮ & ⋱ & ⋮ \\ {s}_{0 , 2} {d}_{L , 1}^{0 , 2} & ⋯ & {s}_{0 , 2} {d}_{L , M}^{0 , 2} \\ {s}_{1 , 2} {d}_{L + 1 , 1}^{1 , 2} & ⋯ & {s}_{1 , 2} {d}_{L + 1 , M}^{1 , 2} \\ ⋮ & ⋱ & ⋮ \\ {s}_{1 , 2} {d}_{2 L , 1}^{1 , 2} & ⋯ & {s}_{1 , 2} {d}_{2 L , M}^{1 , 2}\end{matrix} ]$$

Further, reference amplitudes s_{0,1}, s_{1,1}, s_{0,2}, and S_{1,2} are quantized with a bits, while an amplitude and a phase of the differential coefficient are quantized with b bits and c bits respectively.

As another possible implementation, the terminal device may perform a multiplication operation on reference amplitudes in the combining coefficient matrix of the TRP or TRP group by the amplitude factor of the TRP or TRP group, and quantize a multiplication operation result. Optionally, the terminal device may perform a multiplication operation on differential coefficients in the combining coefficient matrix of the TRP or TRP group by the phase factor of the TRP or TRP group, and quantize a multiplication operation result.

As another possible implementation, the terminal device may perform a multiplication operation on reference amplitudes in the combining coefficient matrix of the TRP or TRP group by the amplitude factor of the TRP or TRP group, and quantize a multiplication operation result. Optionally, the terminal device may quantize the phase factor of the TRP or TRP group and differential coefficients in the combining coefficient matrix of the TRP or TRP group independently.

For example, the amplitude factor of the TRP group is multiplied by the reference amplitudes of \tilde{W}_{2,n}, and then quantized, that is, α₁r_{0,1}, α₁r_{1,1}, and α₂r_{0,2}, α₂r_{1,2} are quantized by a bits, and the amplitudes of other differential coefficients are quantized by b bits. The phase factors ρ₁ and ρ₂ are multiplied by the phase of the differential coefficient and then quantized by c bits. Optionally, the phase factor is quantized by d bits, and the phase of the differential coefficient is quantized by e bits.

Optionally, the amplitude factors α₁ and α₂ are quantized by a bits.

Continuing the above example, the first TRP and the second TRP are two independent TRPs, and the first TRP and the second TRP do not belong to one TRP group. The phase factor and the amplitude factor corresponding to the first TRP are ρ₁, α₁, respectively. The phase factor and the amplitude factor corresponding to the second TRP are ρ₂, α₂, respectively.

Optionally, the amplitude factors α₁, α₂ and the phase factors ρ₁, ρ₂ can be normalized to obtain the following formulation:

$$= [ \begin{matrix}{r}_{0 , 1} {c}_{1 , 1}^{0 , 1} & ⋯ & {r}_{0 , 1} {c}_{1 , M}^{0 , 1} \\ ⋮ & ⋱ & ⋮ \\ {r}_{0 , 1} {c}_{L , 1}^{0} & ⋯ & {r}_{0 , 1} {c}_{L , M}^{0} \\ {r}_{1 , 1} {c}_{L + 1 , 1}^{1} & ⋯ & {r}_{1 , 1} {c}_{L + 1 , M}^{1} \\ ⋮ & ⋱ & ⋮ \\ {r}_{1 , 1} {c}_{2 L , 1}^{1} & ⋯ & {r}_{1 , 1} {c}_{2 L , M}^{1}\end{matrix} ] , = \frac{{a}_{2} {p}_{2}}{{a}_{1} {p}_{1}} [ \begin{matrix}{r}_{0 , 2} {c}_{1 , 1}^{0 , 2} & ⋯ & {r}_{0 , 2} {c}_{1 , M}^{0 , 2} \\ ⋮ & ⋱ & ⋮ \\ {r}_{0 , 2} {c}_{L , 1}^{0 , 2} & ⋯ & {r}_{0 , 2} {c}_{L , M}^{0 , 2} \\ {r}_{1 , 2} {c}_{L + 1 , 1}^{1 , 2} & ⋯ & {r}_{1 , 2} {c}_{L + 1 , M}^{1 , 2} \\ ⋮ & ⋱ & ⋮ \\ {r}_{1 , 2} {c}_{2 L , 1}^{1 , 2} & ⋯ & {r}_{1 , 2} {c}_{2 L , M}^{1 , 2}\end{matrix} ]$$

It should be noted that when the phase factor and the amplitude factor corresponding to the first TRP are 1, there is no need to report the phase factor and the amplitude factor corresponding to the first TRP.

At step 402, a quantized result is sent to the network device in the wideband manner.

In an embodiment of the present disclosure, the quantized result obtained by erforming a multiplication operation on the combining coefficient matrix by the phase factor or the amplitude factor and quantizing a multiplication operation result, may be sent to the network device in the wideband manner.

In an embodiment of the present disclosure, at least one factor of the phase factor or the amplitude factor of the TRP or TRP group is sent to the network device based on the combining coefficient matrix of the TRP or TRP group. At least one factor of the phase factor or the amplitude factor of the TRP or TRP group may be incorporated into the combining coefficient matrix of the TRP or TRP group and is sent to the network device, which may reduce a signaling overhead occupied when a terminal device directly feeds back the phase factor and amplitude factor to the network device. Furthermore, the present disclosure may cause the network device to understand a TRP status of the terminal device, and then determine downlink transmission precoding.

Please refer to FIG. 5, FIG. 5 is a flowchart illustrating a method for sending a phase factor and an amplitude factor of a TRP or TRP group according to an embodiment of the present disclosure. The method for sending a phase factor and an amplitude factor is performed by a terminal device. As illustrated in FIG. 5, the method may include, but is not limited to, following steps.

At step 501, a multiplication operation is performed on the combining coefficient matrix of the TRP or TRP group by the amplitude factor of the TRP or TRP group, and a multiplication operation result is quantized.

Optionally, a multiplication operation is performed on reference amplitudes in the combining coefficient matrix of the TRP or TRP group by the amplitude factor of the TRP or TRP group, and a multiplication operation result is quantized.

At step 502, a multiplication operation is performed on the combining coefficient matrix of the TRP or TRP group by the wideband phase factor of the TRP or TRP group, and a multiplication operation result is quantized.

In an embodiment of the present disclosure, the phase factor includes a wideband phase factor and a sub-band phase factor. Optionally, the terminal device may perform the multiplication operation on differential coefficients in the combining coefficient matrix of the TRP or TRP group by the wideband phase factor, and quantize the multiplication operation result.

At step S503, the sub-band phase factor is quantized.

Optionally, the terminal device may directly quantize the sub-band phase factor independently. For example, the sub-band phase factor may be quantized directly using n bits.

Optionally, the terminal device may process the sub-band phase factor through the sub-band combining coefficient matrix and then quantize a processing result. In some implementations, the terminal device determines a sub-band combining coefficient matrix corresponding to the TRP group, and obtains a first sub-band combining coefficient matrix by multiplying the sub-band phase factor by the sub-band combining coefficient matrix. Further, the terminal device may compress and quantize the first sub-band combining coefficient matrix based on a frequency domain basis vector. That is, the terminal device may obtain the compressed first sub-band combining coefficient matrix by multiplying an FD basis vector W_{ƒ} with the first sub-band combining coefficient matrix. Further, the terminal device may quantize the compressed first sub-band combining coefficient matrix by preset bits.

At step S504, the quantized result is sent to the network device in the wideband manner and/or the sub-band manner.

Optionally, a quantized result corresponding to the amplitude factor and a quantized result corresponding to the wideband phase factor are sent to the network device in the wideband manner, and a quantized result corresponding to the sub-band phase factor is sent to the network device in the sub-band manner. That is, the terminal device sends to the network device the quantized result obtained by performing the multiplication operation on the combining coefficients of the TRP or TRP group by the amplitude factor and quantizing a multiplication operation result, and the quantized result obtained by performing the multiplication operation on the combining coefficients of the TRP or TRP group by the wideband phase factor and quantizing a multiplication operation result in the wideband manner.

Optionally, a quantized result corresponding to the amplitude factor is sent to the network device in the wideband manner, and a quantized result corresponding to the phase factor is sent to the network device in the sub-band manner. It should be noted that the quantized result of the phase factor includes a quantized result of the wideband phase factor and a quantized results of the sub-band phase factor. In an embodiment of the present disclosure, the terminal device may send the quantized result of the wideband phase factor and the quantized result of the sub-band phase factor to the network device in the sub-band manner.

As an example, two TRPs serve an edge UE through CJT. The UE obtains respective combining coefficient matrixes corresponding to the two TRPs based on a calculation method of the existing Type II codebook based on downlink channels from the two TRPs to the UE. The combining coefficient matrixes are provided as \tilde{W}_{2,1} and \tilde{W}_{2,2} in the above embodiment.

The implementation that the terminal device performs a multiplication operation on reference amplitudes in the combining coefficient matrix of the TRP or TRP group by the amplitude factor of the TRP or TRP group, and quantizes a multiplication operation result may refer to the relevant content described in the above embodiment, which will not be repeated here.

The phase factor of the TRP or TRP group may include a WB phase factor and an SB phase factor. The implementation of performing a multiplication operation on the differential coefficients in the combining coefficient matrix of the TRP or TRP group by the WB phase factor and quantizing a multiplication operation result may refer to the relevant content described in the above embodiment, which will not be repeated here.

Assumed that the number of sub-bands is N₃. For the n-th sub-band of the 1-th TRP, one sub-band phase factor is reported as ρ_{l,n}, l=1, 2, or for the n-th sub-band of the 1-th TRP, two sub-band phase factors are reported as ρ_{l,n,0} ρ_{l,n,1}, where subscripts 0 and 1 represent a first polarization direction and a second polarization direction respectively. The SB phase factor of each sub-band is reported through x bits.

For example, the sub-band phase factor of the TRP is ρ_{l,n}, and the sub-band combining coefficients S corresponding to the TRP is expressed as:

$$S = [ \begin{matrix}{c}_{1 , 1}^{0 , 1} & ⋯ & {c}_{1 , {N}_{3}}^{0 , 1} \\ ⋮ & ⋱ & ⋮ \\ {c}_{L , 1}^{0} & ⋯ & {c}_{L , {N}_{3}}^{0} \\ {c}_{L + 1 , 1}^{1} & ⋯ & {c}_{L + 1 , {N}_{3}}^{1} \\ ⋮ & ⋱ & ⋮ \\ {c}_{2 L , 1}^{1} & ⋯ & {c}_{2 L , {N}_{3}}^{1}\end{matrix} ] ;$$

A second sub-band combining coefficient matrix T is obtained by multiplying each sub-band amplitude factor ρ_{l,n} by the sub-band combining coefficients S, and the second sub-band combining coefficient matrix T is provided as follows:

$$T = [ \begin{matrix}{p}_{l , 1} {c}_{1 , 1}^{0 , 1} & ⋯ & {p}_{l , {N}_{3}} {c}_{1 , {N}_{3}}^{0 , 1} \\ ⋮ & ⋱ & ⋮ \\ {p}_{l , 1} {c}_{L , 1}^{0} & ⋯ & {p}_{l , {N}_{3}} {c}_{L , {N}_{3}}^{0} \\ {p}_{l , 1} {c}_{L + 1 , 1}^{1} & ⋯ & {p}_{l , {N}_{3}} {c}_{L + 1 , {N}_{3}}^{1} \\ ⋮ & ⋱ & ⋮ \\ {p}_{l , 1} {c}_{2 L , 1}^{1} & ⋯ & {p}_{l , {N}_{3}} {c}_{2 L , {N}_{3}}^{1}\end{matrix} ]$$

Further, the second sub-band combining coefficient matrix T is compressed and quantized based on M frequency domain basis vectors of the TRP or TRP group, and the compressed second sub-band combining coefficient matrix is sent to the network device in the wideband manner or in the sub-band manner.

In an embodiment of the present disclosure, at least one factor of the phase factor or the amplitude factor of the TRP or TRP group is sent to the network device based on the combining coefficient matrix of the TRP or TRP group. At least one factor of the phase factor or the amplitude factor of the TRP or TRP group may be incorporated into the combining coefficient matrix of the TRP or TRP group and is sent to the network device, which may reduce a signaling overhead occupied when a terminal device directly feeds back the phase factor and amplitude factor to the network device. Furthermore, the present disclosure may cause the network device to understand a TRP status of the terminal device, and then determine downlink transmission precoding.

Please refer to FIG. 6, FIG. 6 is a flowchart illustrating a method for sending a phase factor and an amplitude factor of a TRP or TRP group according to an embodiment of the present disclosure. The method for sending a phase factor and an amplitude factor is performed by a terminal device. As illustrated in FIG. 6, the method may include, but is not limited to, following steps.

At step 601, a multiplication operation is performed on the combining coefficient matrix of the TRP or TRP group by the phase factor of the TRP or TRP group, and a multiplication operation result is quantized.

Optionally, a multiplication operation is performed on differential coefficients in the combining coefficient matrix of the TRP or TRP group by the phase factor of the TRP or TRP group, and a multiplication operation result is quantized.

At step 602, a multiplication operation is performed on the combining coefficient matrix of the TRP or TRP group by the wideband amplitude factor of the TRP or TRP group, and a multiplication operation result is quantized.

In an embodiment of the present disclosure, the amplitude factor includes a wideband amplitude factor and a sub-band amplitude factor. Optionally, the terminal device may perform the multiplication operation on reference amplitudes in the combining coefficient matrix of the TRP or TRP group by the wideband amplitude factor, and quantize the multiplication operation result.

At step S603, the sub-band amplitude factor is quantized.

Optionally, the terminal device may directly quantize the sub-band amplitude factor independently. For example, the sub-band amplitude factor may be quantized directly using n bits.

Optionally, the terminal device may process the sub-band amplitude factor through the sub-band combining coefficient matrix and then quantize a processing result. In some implementations, the terminal device determines a sub-band combining coefficient matrix corresponding to the TRP group, and obtains a second sub-band combining coefficient matrix by multiplying the sub-band amplitude factor by the sub-band combining coefficient matrix. Further, the terminal device may compress and quantize the second sub-band combining coefficient matrix based on a frequency domain basis vector. That is, the terminal device may obtain the compressed second sub-band combining coefficient matrix by multiplying an FD basis vector W_{ƒ} with the second sub-band combining coefficient matrix. Further, the terminal device may quantize the compressed second sub-band combining coefficient matrix by preset bits.

At step S604, the quantized result is sent to the network device in the wideband manner and/or the sub-band manner.

Optionally, a quantized result corresponding to the phase factor and a quantized result corresponding to the wideband amplitude factor are sent to the network device in the wideband manner, and a quantized result corresponding to the sub-band amplitude factor is sent to the network device in the sub-band manner. That is, the terminal device sends to the network device the quantized result obtained by performing the multiplication operation on the combining coefficients by the phase factor and quantizing a multiplication operation result, and the quantized result obtained by performing the multiplication operation on the combining coefficients by the wideband amplitude factor and quantizing a multiplication operation result in the wideband manner.

Optionally, a quantized result corresponding to the phase factor is sent to the network device in the wideband manner, and a quantized result corresponding to the amplitude factor is sent to the network device in the sub-band manner. It should be noted that the quantized result of the amplitude factor includes a quantized result of the wideband amplitude factor and a quantized results of the sub-band amplitude factor. In an embodiment of the present disclosure, the terminal device may send the quantized result of the wideband phase factor and the quantized result of the sub-band phase factor to the network device in the sub-band manner.

In an embodiment of the present disclosure, at least one factor of the phase factor or the amplitude factor of the TRP or TRP group is sent to the network device based on the combining coefficient matrix of the TRP or TRP group. At least one factor of the phase factor or the amplitude factor of the TRP or TRP group may be incorporated into the combining coefficient matrix of the TRP or TRP group and is sent to the network device, which may reduce a signaling overhead occupied when a terminal device directly feeds back the phase factor and amplitude factor to the network device. Furthermore, the present disclosure may cause the network device to understand a TRP status of the terminal device, and then determine downlink transmission precoding.

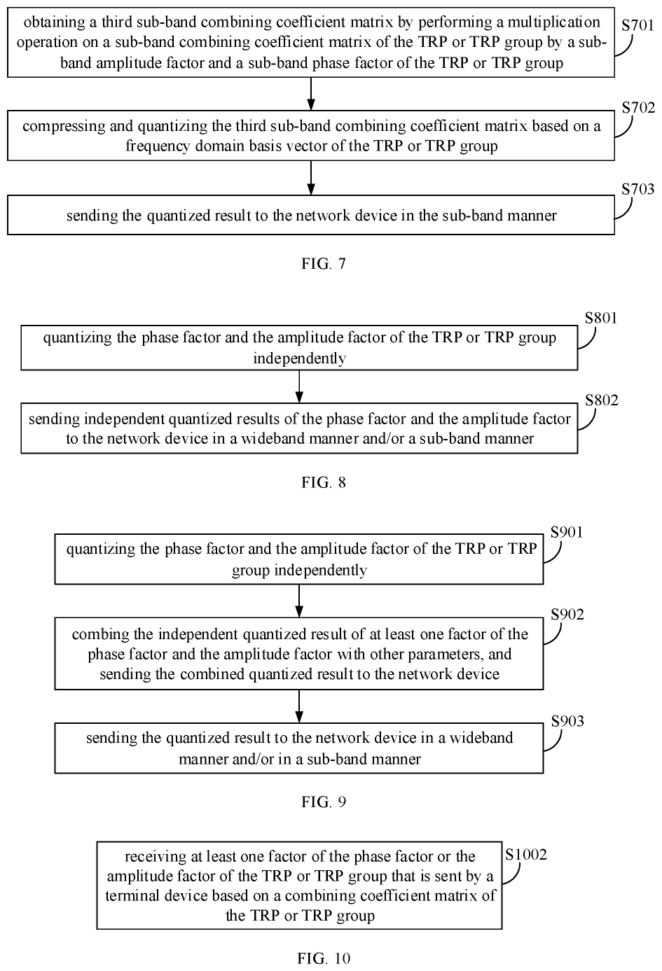

Please refer to FIG. 7, FIG. 7 is a flowchart illustrating a method for sending a phase factor and an amplitude factor of a TRP or TRP group according to an embodiment of the present disclosure. The method for sending a phase factor and an amplitude factor is performed by a terminal device. As illustrated in FIG. 7, the method may include, but is not limited to, following steps.

At step S701, a third sub-band combining coefficient matrix is obtained by performing a multiplication operation on a sub-band combining coefficient matrix of the TRP or TRP group by a sub-band amplitude factor and a sub-band phase factor of the TRP or TRP group.

Optionally, a product of the sub-band amplitude factor and the sub-band phase factor of the TRP or TRP group is determined, and the third sub-band combining coefficient matrix is obtained by performing the multiplication operation on combining coefficients in the sub-band combining coefficient matrix of the TRP or TRP group by the product.

At step S702, the third sub-band combining coefficient matrix is compressed and quantized based on a frequency domain basis vector of the TRP or TRP group.

The terminal device compresses the third sub-band combining coefficient matrix through an FD basis vector W_{ƒ} corresponding to the TRP group, and quantizes the compressed third sub-band combining coefficient matrix. That is, the compressed third sub-band combining coefficient matrix is obtained by multiplying the third sub-band combining coefficient matrix by the FD basis vector W_{ƒ}. The compressed third sub-band combining coefficient matrix is quantized by preset bits.

At step S703, the quantized result is sent to the network device in the sub-band manner.

In this embodiment of the present disclosure, the terminal device may send the quantized result of the sub-band phase factor and the quantized result of the sub-band amplitude factor to the network device in the sub-band manner.

In an embodiment of the present disclosure, at least one factor of the phase factor or the amplitude factor of the TRP or TRP group is sent to the network device based on the combining coefficient matrix of the TRP or TRP group. At least one factor of the phase factor or the amplitude factor of the TRP or TRP group may be incorporated into the combining coefficient matrix of the TRP or TRP group and is sent to the network device, which may reduce a signaling overhead occupied when a terminal device directly feeds back the phase factor and amplitude factor to the network device. Furthermore, the present disclosure may cause the network device to understand a TRP status of the terminal device, and then determine downlink transmission precoding.

Please refer to FIG. 8, FIG. 8 is a flowchart illustrating a method for sending a phase factor and an amplitude factor of a TRP or TRP group according to an embodiment of the present disclosure. The method for sending a phase factor and an amplitude factor is performed by a terminal device. As illustrated in FIG. 8, the method may include, but is not limited to, following steps.

At step S801, the phase factor and the amplitude factor of the TRP or TRP group are quantized independently.

Optionally, the phase factor and the amplitude factor of the TRP or TRP group may be quantized by using the same number of bits or different numbers of bits respectively. For example, the phase factor may be quantized by using n bits, and the amplitude factor may be quantized by using m bits.

Optionally, the amplitude factor may include a wideband amplitude factor and a sub-band amplitude factor, and the phase factor may include a wideband phase factor and a sub-band phase factor. In an embodiment of the present disclosure, the terminal device may independently quantize the sub-band phase factor and the sub-band amplitude factor; and/or the terminal device may independently quantize the wideband phase factor and the wideband amplitude factor.

At step S802, independent quantized results of the phase factor and the amplitude factor are sent to the network device in a wideband manner and/or a sub-band manner.

Optionally, the terminal device may send the independent quantized results of the phase factor and the amplitude factor to the network device in the wideband manner.

Optionally, the terminal device may send the independent quantized results of the phase factor and the amplitude factor to the network device in the sub-band manner.

Optionally, the terminal device may send the independent quantized result of the first factor in the phase factor and the amplitude factor to the network device in the wideband manner, and send the independent quantized result of the second factor in the phase factor and the amplitude factor to the network device in the sub-band manner.

Optionally, the terminal device may send the quantized results of the wideband phase factor and the wideband amplitude factor to the network device in the wideband manner. Further, the terminal device may send the quantized results of the sub-band phase factor and the sub-band amplitude factor to the network device in the sub-band manner.

In an embodiment of the present disclosure, the phase factor and the amplitude factor of the TRP or TRP group are sent to the network device, so that the network device may understand a TRP situation of the terminal device and further determine precoding for downlink transmission.

Please refer to FIG. 9, FIG. 9 is a flowchart illustrating a method for sending a phase factor and an amplitude factor of a TRP or TRP group according to an embodiment of the present disclosure. The method for sending a phase factor and an amplitude factor is performed by a terminal device. As illustrated in FIG. 9, the method may include, but is not limited to, following steps.

At step S901, the phase factor and the amplitude factor of the TRP or TRP group are quantized independently.

For a detailed introduction to step S901, please refer to the relevant content records in the above embodiments, which will not be repeated here.

At step S902, the independent quantized result of at least one factor of the phase factor and the amplitude factor is combined with other parameters, and the combined quantized result is sent to the network device.

Optionally, the other parameters may be reference amplitudes and/or differential coefficients in the combining coefficient matrix of the TRP or TRP group.

Optionally, the independent quantized results corresponding to the phase factor and the amplitude factor may be combined with other parameters to obtain the combined quantized result.

Optionally, an independent quantized result corresponding to a first factor in the phase factor and the amplitude factor may be combined with other parameters to obtain the combined quantized result.

Optionally, an independent quantized result corresponding to at least one sub-band factor in a sub-band phase factor and a sub-band amplitude factor may be combined with other parameters to obtain the combined quantized result.

Optionally, an independent quantized result of at least one wideband factor in the wideband phase factor and the wideband amplitude factor may be combined with other parameters to obtain the combined quantized result.

At step S903, the quantized result is sent to the network device in a wideband manner and/or in a sub-band manner.

Optionally, the terminal device may send the independent quantized results of the phase factor and the amplitude factor to the network device in the wideband manner.

Optionally, the terminal device may send the independent quantized results of the phase factor and the amplitude factor to the network device in the sub-band manner.

Optionally, the terminal device may send the independent quantized result of the first factor in the phase factor and the amplitude factor to the network device in the wideband manner, and send the independent quantized result of the second factor in the phase factor and the amplitude factor to the network device in the sub-band manner.

Optionally, the terminal device may send the quantized results of the wideband phase factor and the wideband amplitude factor to the network device in the wideband manner.

Further, the terminal device may send the quantized results of the sub-band phase factor and the sub-band amplitude factor to the network device in the sub-band manner.

Optionally, in a case where the independent quantized results of the two factors are combined with other parameters, the terminal device may send the combined quantized result to the network device in the wideband manner or in the sub-band manner.

Optionally, in a case where the independent quantized result of the first factor in the phase factor and the amplitude factor is combined with other parameters, the combined quantized result may be sent to the network device in the sub-band manner, and the independent quantized result of the second factor in the amplitude factor and the phase factor may be sent to the network device in the wideband manner.

For example, the first factor may be the phase factor and the second factor may be the amplitude factor, or the first factor may be the amplitude factor and the second factor may be the phase factor.

Optionally, in a case that the independent quantized result of at least one factor of the sub-band phase factor and the sub-band amplitude factor may be combined with other parameters, the combined quantized result may be sent to the network device in the sub-band manner, and independent quantized results of the wideband phase factor and the wideband amplitude factor are sent to the network device in the wideband manner.

Optionally, in a case that the independent quantized result of at least one factor of the wideband phase factor and the wideband amplitude factor may be combined with other parameters, the combined quantized result may be sent to the network device in the wideband manner, and independent quantized results of the sub-band phase factor and the sub-band amplitude factor are sent to the network device in the sub-band manner.

In an embodiment of the present disclosure, the phase factor and the amplitude factor of the TRP or TRP group are sent to the network device, so that the network device can understand a TRP situation of the terminal device and further determine precoding for downlink transmission.

Applicable to any of the above embodiments, it should be noted that a sum of normalized amplitude factors and normalized phase factors of all TRPs or TRP groups corresponding to the terminal device is 1. In an embodiment of the present disclosure, at least one TRP or TRP group without necessary to report the phase factor and/or the amplitude factor is present in all TRPs or TRP groups. Optionally, the terminal device may indicate to the network device at least one TRP or TRP group without necessary to report the phase factor and/or the amplitude factor through indication information. The indication information may occupy N bits.

For example, the terminal device may indicate without reporting at least one of the WB phase factor and the SB phase factor, or without reporting at least one of the WB amplitude factor and the SB amplitude factor. Optionally, the TRP or TRP group without necessary to report the phase factor and/or the amplitude factor to the network device may be pre-configured by the network device or predefined by the terminal device. For example, the TRP or TRP group without necessary to report the phase factor and/or the amplitude factor to the network device may be a TRP or TRP group with the phase factor and/or amplitude factor being 1 after normalization is completed for \tilde{W}₂.

Please refer to FIG. 10, FIG. 10 is a flowchart illustrating a method for receiving a phase factor and an amplitude factor of a TRP or TRP group according to an embodiment of the present disclosure. The method for receiving a phase factor and an amplitude factor is performed by a network device. As illustrated in FIG. 10, the method may include, but is not limited to, a following step.

At step S1001, at least one factor of the phase factor or the amplitude factor of the TRP or TRP group that is sent by a terminal device based on a combining coefficient matrix of the TRP or TRP group is received.

The TRP group includes at least one TRP.

In order to realize downlink data transmission, the network device requires to acquire the amplitude factor and the phase factor of the TRP or TRP group of the terminal device, and then determine downlink transmission precoding of the terminal device based on a codebook and the amplitude factor and the phase factor of the TPR group.

Optionally, the network device may receive the phase factor and/or the amplitude factor corresponding to the TRP or TPR group reported implicitly by the terminal device. In some implementations, the terminal device sends at least one factor of the phase factor or the amplitude factor of the TRP or TRP group to the network device based on the combining coefficient matrix of the TRP or TRP group. That is, the terminal device incorporates at least one factor of the phase factor and the amplitude factor into the combining coefficient matrix, and the network device may receive the combining coefficient matrix that incorporates at least one of the phase factor and the amplitude factor and is reported by the terminal device, to determine the phase factor and/or the amplitude factor of the TRP or TRP group based on the received combining coefficient matrix of the TRP or TRP group.

Optionally, the network device receives the combining coefficient matrix of the TRP or the TRP group sent by the terminal device in a wideband manner and/or a sub-band manner, and the combining coefficient matrix of the TRP or TRP group carries at least one factor in the phase factor and the amplitude factor of the TRP or TRP group.

In an implementation, the terminal device may incorporate a first factor in the phase factor and the amplitude factor of the TRP or TRP group into the combining coefficient matrix of the TRP or TRP group, and may send the first factor to the network device in the wideband manner or in the sub-band manner. Correspondingly, the network device may receive the combining coefficient matrix of the TRP or the TRP group carrying the first factor in the wideband manner or the sub-band manner. The first factor may be the phase factor and the second factor may be the amplitude factor; or the first factor may be the amplitude factor and the second factor may be the phase factor.

In another implementation, the terminal device may incorporate the phase factor and the amplitude factor of the TRP or TRP group into the combining coefficient matrix of the TRP or TRP group, and may send the combining coefficient matrix to the network device in the wideband manner or in the sub-band manner. Correspondingly, the network device may receive the combining coefficient matrix of the TRP or TRP group carrying the two factors in the wideband manner or the sub-band manner.

In an embodiment of the present disclosure, at least one factor of the phase factor or the amplitude factor of the TRP or TRP group sent by the terminal device based on the combining coefficient matrix of the TRP or TRP group is received. In this disclosure, at least one factor of the phase factor and the amplitude factor of the TRP or TRP group is incorporated into the combining coefficient matrix of the TRP or TRP group and reported to the network device, which may reduce a signaling overhead occupied by the network device when receiving the phase factor and the amplitude factor directly fed back by terminal device. Further, the network device may understand a TRP status of the terminal device, and then determine precoding for downlink transmission.

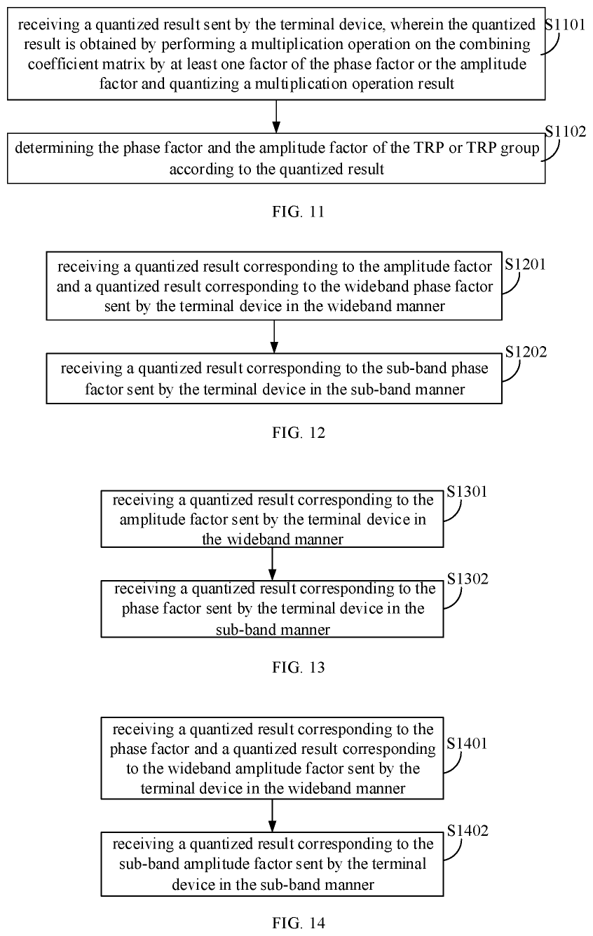

Please refer to FIG. 11, FIG. 11 is a flowchart illustrating a method for receiving a phase factor and an amplitude factor of a TRP or TRP group according to an embodiment of the present disclosure. The method for receiving a phase factor and an amplitude factor is performed by a network device. As illustrated in FIG. 11, the method may include, but is not limited to, following steps.

At step S1101, a quantized result sent by the terminal device is received, in which, the quantized result is obtained by performing a multiplication operation on the combining coefficient matrix by at least one factor of the phase factor or the amplitude factor and quantizing a multiplication operation result.

Optionally, the terminal device may perform the multiplication operation on the combining coefficient matrix by the phase factor and the amplitude factor of the TRP or TRP group and a multiplication operation result is quantized.

Optionally, the terminal device may perform the multiplication operation on the combining coefficient matrix by the phase factor of the TRP or TRP group and a multiplication operation result is quantized. Furthermore, the amplitude factor of the TRP or TRP group may be quantized independently.

Optionally, the terminal device may perform the multiplication operation on the combining coefficient matrix by the amplitude factor of the TRP or TRP group and a multiplication operation result is quantized. Furthermore, the phase factor of the TRP or TRP group may be quantized independently.

Optionally, the terminal device may perform the multiplication operation on the combining coefficient matrix by a first factor in the phase factor and the amplitude factor and a wideband factor part of a second factor in the phase factor and the amplitude factor, and a multiplication operation result is quantized. Furthermore, a sub-band factor part of the second factor may be independently quantized.

Optionally, the terminal device may perform a multiplication operation on the combining coefficient matrix by the sub-band factor part of the phase factor and the amplitude factor, and a multiplication operation result may be quantized. Further, the wideband factor part of the phase factor and the amplitude factor may be independently quantized. It should be noted that the combining coefficient matrix may be a sub-band combining coefficient matrix.

Optionally, the network device may receive a quantized result corresponding to at least one factor of the phase factor or the amplitude factor sent by the terminal device in a wideband manner and/or in a sub-band manner.

Optionally, the network device may receive a quantized result corresponding to the phase factor in the wideband manner; and receives a quantized result corresponding to the amplitude factor in the wideband manner.

Optionally, the network device may receive a quantized result corresponding to the phase factor sent by the terminal device in the wideband manner; and receives a quantized result corresponding to the amplitude factor sent by the terminal device in the wideband manner.

Optionally, the network device may receive receiving a quantized result corresponding to a first factor in the phase factor and the amplitude factor sent by the terminal device in the wideband manner, and receive a quantized result corresponding to a second factor in the phase factor and the amplitude factor in the sub-band manner.

Optionally, the network device may receive a quantized result corresponding to the phase factor sent by the terminal device in the sub-band manner, and receive a quantized result corresponding to the amplitude factor sent by the terminal device in the sub-band manner.

At step S1102, the phase factor and the amplitude factor of the TRP or TRP group is determined according to the quantized result.

Optionally, after receiving the quantized result corresponding to at least one factor of the phase factor and the amplitude factor, the network device may perform reverse quantization on the quantized result, to determine the phase factor and/or the amplitude factor of the TRP or TRP group.

In an embodiment of the present disclosure, at least one factor of the phase factor or the amplitude factor of the TRP or TRP group sent by the terminal device based on the combining coefficient matrix of the TRP or TRP group is received. In this disclosure, at least one factor of the phase factor and the amplitude factor of the TRP or TRP group is incorporated into the combining coefficient matrix of the TRP or TRP group and reported to the network device, which may reduce a signaling overhead occupied by the network device when receiving the phase factor and the amplitude factor directly fed back by terminal device. Further, the network device may understand a TRP status of the terminal device, and then determine precoding for downlink transmission.

Please refer to FIG. 12, FIG. 12 is a flowchart illustrating a method for receiving a phase factor and an amplitude factor of a TRP or TRP group according to an embodiment of the present disclosure. The method for receiving a phase factor and an amplitude factor is performed by a network device. In a scenario where the network device may receive the phase factor and the amplitude factor in a wideband manner and in a sub-band manner, as illustrated in FIG. 12, the method may include, but is not limited to, following steps.

At step S1201, a quantized result corresponding to the amplitude factor and a quantized result corresponding to the wideband phase factor sent by the terminal device are received in the wideband manner.

In an embodiment of the present disclosure, the phase factor includes the wideband phase factor and a sub-band phase factor.

The quantized result corresponding to the amplitude factor is obtained by multiplying the amplitude factor and the combining coefficient matrix of the TRP or TRP group and quantizing the multiplication operation result, a specific process of which may refer to the disclosure of the relevant content in the above embodiments, which will not be repeated here.

The quantized result corresponding to the wideband phase factor is obtained by multiplying the wideband phase factor and the combining coefficient matrix of the TRP or TRP group and quantizing the multiplication operation result, a specific process of which may refer to the disclosure of the relevant content in the above embodiments, which will not be repeated here.

Optionally, the network device may receive the quantized result corresponding to the amplitude factor and the quantized result corresponding to the wideband phase factor sent by the terminal device in the wideband manner.

At step S1202, a quantized result corresponding to the sub-band phase factor sent by the terminal device is received in the sub-band manner.

Optionally, the quantized result corresponding to the sub-band phase factor may be a result of direct quantization by the terminal device.

Optionally, the quantized result corresponding to the sub-band phase factor may be obtained by multiplying the sub-band phase factor by the sub-band combining coefficient matrix of the TRP or TRP group, and compressing and quantizing a multiplication operation result based on a frequency domain basis vector of the TRP or TRP group, a specific process of which may refer to the disclosure of the relevant content in the above embodiments, which will not be repeated here.

Optionally, the network device may receive the quantized result corresponding to the sub-band phase factor sent by the terminal device in the sub-band manner.

In an embodiment of the present disclosure, at least one factor of the phase factor or the amplitude factor of the TRP or TRP group sent by the terminal device based on the combining coefficient matrix of the TRP or TRP group is received. In this disclosure, at least one factor of the phase factor and the amplitude factor of the TRP or TRP group is incorporated into the combining coefficient matrix of the TRP or TRP group and reported to the network device, which may reduce a signaling overhead occupied by the network device when receiving the phase factor and the amplitude factor directly fed back by terminal device. Further, the network device may understand a TRP status of the terminal device, and then determine precoding for downlink transmission.

Please refer to FIG. 13, FIG. 13 is a flowchart illustrating a method for receiving a phase factor and an amplitude factor of a TRP or TRP group according to an embodiment of the present disclosure. The method for receiving a phase factor and an amplitude factor of a TRP or TRP group is performed by a network device. In a scenario where the network device may receive the phase factor and the amplitude factor in a wideband manner and in a sub-band manner, as illustrated in FIG. 13, the method may include, but is not limited to, following steps.

At step S1301, a quantized result corresponding to the amplitude factor sent by the terminal device is received in the wideband manner.

In an embodiment of the present disclosure, the phase factor includes a wideband phase factor and a sub-band phase factor.

The quantized result corresponding to the amplitude factor is obtained by multiplying the amplitude factor and the combining coefficient matrix of the TRP or TRP group and quantizing the multiplication operation result, a specific process of which may refer to the disclosure of the relevant content in the above embodiments, which will not be repeated here.

Optionally, the network device may receive the quantized result corresponding to the amplitude factor sent by the terminal device in the wideband manner.

At step S1302, a quantized result corresponding to the phase factor sent by the terminal device is received in the sub-band manner.

In an embodiment of the present disclosure, the quantized result of the phase factor includes a quantized result of the wideband phase factor and a quantized result of the sub-band phase factor.

The quantized result corresponding to the wideband phase factor is obtained by multiplying the wideband phase factor and the combining coefficient matrix of the TRP or TRP group and quantizing the multiplication operation result, a specific process of which may refer to the disclosure of the relevant content in the above embodiments, which will not be repeated here.

Alternatively, the quantized result corresponding to the sub-band phase factor may be a result of direct quantization by the terminal device. Or, the quantized result corresponding to the sub-band phase factor may be obtained by multiplying the sub-band phase factor by the sub-band combining coefficient matrix of the TRP or TRP group, and compressing and quantizing a multiplication operation result based on a frequency domain basis vector of the TRP or TRP group, a specific process of which may refer to the disclosure of the relevant content in the above embodiments, which will not be repeated here.

Optionally, the network device may receive the quantized result corresponding to the phase factor sent by the terminal device in the sub-band manner, that is, receive the quantized result of the wideband phase factor and the quantized result of the sub-band phase factor sent by the terminal device in the sub-band manner.

In an embodiment of the present disclosure, at least one factor of the phase factor or the amplitude factor of the TRP or TRP group sent by the terminal device based on the combining coefficient matrix of the TRP or TRP group is received. In this disclosure, at least one factor of the phase factor and the amplitude factor of the TRP or TRP group is incorporated into the combining coefficient matrix of the TRP or TRP group and reported to the network device, which may reduce a signaling overhead occupied by the network device when receiving the phase factor and the amplitude factor directly fed back by terminal device. Further, the network device may understand a TRP status of the terminal device, and then determine precoding for downlink transmission.

Please refer to FIG. 14, FIG. 14 is a flowchart illustrating a method for receiving a phase factor and an amplitude factor of a TRP or TRP group according to an embodiment of the present disclosure. The method for receiving a phase factor and an amplitude factor is performed by a network device. In a scenario where the network device may receive the phase factor and the amplitude factor in a wideband manner and in a sub-band manner, as illustrated in FIG. 14, the method may include, but is not limited to, following steps.

At step S1401, a quantized result corresponding to the phase factor and a quantized result corresponding to the wideband amplitude factor sent by the terminal device are received in the wideband manner.

In an embodiment of the present disclosure, the amplitude factor includes a wideband amplitude factor and a sub-band amplitude factor.

The quantized result corresponding to the phase factor is obtained by multiplying the phase factor and the combining coefficient matrix of the TRP or TRP group and quantizing the multiplication operation result, a specific process of which may refer to the disclosure of the relevant content in the above embodiments, which will not be repeated here.

The quantized result corresponding to the wideband amplitude factor is obtained by multiplying the wideband amplitude factor and the combining coefficient matrix of the TRP or TRP group and quantizing the multiplication operation result, a specific process of which may refer to the disclosure of the relevant content in the above embodiments, which will not be repeated here.

Optionally, the network device may receive

Optionally, the network device may receive the quantized result corresponding to the phase factor and the quantized result corresponding to the wideband amplitude factor sent by the terminal device in the wideband manner.

At step S1402, a quantized result corresponding to the sub-band amplitude factor sent by the terminal device is received in a sub-band manner.

Optionally, the quantized result corresponding to the sub-band amplitude factor may be a result of direct quantization by the terminal device.

Optionally, the quantized result corresponding to the sub-band amplitude factor is obtained by multiplying the sub-band amplitude factor by the sub-band combining coefficient matrix of the TRP or TRP group, and compressing and quantizing a multiplication operation result based on a frequency domain basis vector of the TRP or TRP group, a specific process of which may refer to the disclosure of the relevant content in the above embodiments, which will not be repeated here.

Optionally, the network device may receive the quantized result corresponding to the sub-band amplitude factor sent by the terminal device in the sub-band manner.

In an embodiment of the present disclosure, at least one factor of the phase factor or the amplitude factor of the TRP or TRP group sent by the terminal device based on the combining coefficient matrix of the TRP or TRP group is received. In this disclosure, at least one factor of the phase factor and the amplitude factor of the TRP or TRP group is incorporated into the combining coefficient matrix of the TRP or TRP group and reported to the network device, which may reduce a signaling overhead occupied by the network device when receiving the phase factor and the amplitude factor directly fed back by terminal device. Further, the network device may understand a TRP status of the terminal device, and then determine precoding for downlink transmission.

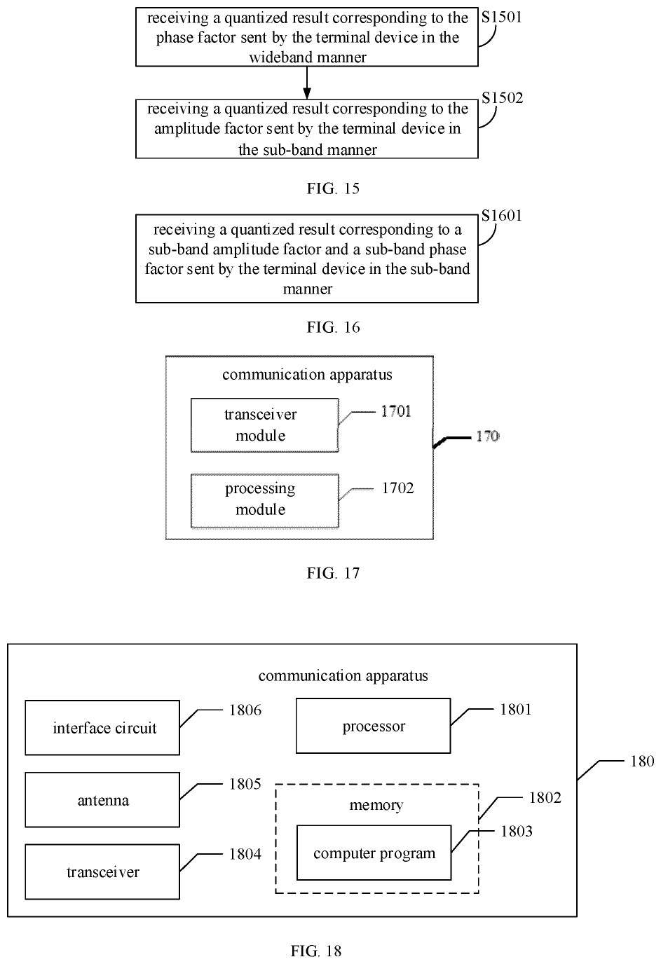

Please refer to FIG. 15, FIG. 15 is a flowchart illustrating a method for receiving a phase factor and an amplitude factor of a TRP or TRP group according to an embodiment of the present disclosure. The method for receiving a phase factor and an amplitude factor of a TRP or TRP group is performed by a network device. In a scenario where the network device may receive the phase factor and the amplitude factor in a wideband manner and in a sub-band manner, as illustrated in FIG. 15, the method may include, but is not limited to, following steps.

At step S1501, a quantized result corresponding to the phase factor sent by the terminal device is received in the wideband manner.

In an embodiment of the present disclosure, the amplitude factor includes a wideband amplitude factor and a sub-band amplitude factor.

The quantized result corresponding to the phase factor is obtained by multiplying the phase factor and the combining coefficient matrix of the TRP or TRP group and quantizing the multiplication operation result, a specific process of which may refer to the disclosure of the relevant content in the above embodiments, which will not be repeated here.

Optionally, the network device may receive the quantized result corresponding to the phase factor sent by the terminal device in the wideband manner.

At step S1502, a quantized result corresponding to the amplitude factor sent by the terminal device is received in a sub-band manner.

In an embodiment of the present disclosure, the quantized result of the amplitude factor includes a quantized result of the wideband amplitude factor and a quantized result of the sub-band amplitude factor.

The quantized result corresponding to the wideband amplitude factor is obtained by multiplying the wideband amplitude factor and the combining coefficient matrix of the TRP or TRP group and quantizing the multiplication operation result, a specific process of which may refer to the disclosure of the relevant content in the above embodiments, which will not be repeated here.

Alternatively, the quantized result corresponding to the sub-band amplitude factor may be a result of direct quantization by the terminal device. Or, the quantized result corresponding to the sub-band amplitude factor may be obtained by multiplying the sub-band amplitude factor by the sub-band combining coefficient matrix of the TRP or TRP group, and compressing and quantizing a multiplication operation result based on a frequency domain basis vector of the TRP or TRP group, a specific process of which may refer to the disclosure of the relevant content in the above embodiments, which will not be repeated here.

Optionally, the network device may receive the quantized result corresponding to the amplitude factor sent by the terminal device in the sub-band manner, that is, receive the quantized result of the wideband amplitude factor and the quantized result of the sub-band amplitude factor sent by the terminal device in the sub-band manner.

In an embodiment of the present disclosure, at least one factor of the phase factor or the amplitude factor of the TRP or TRP group sent by the terminal device based on the combining coefficient matrix of the TRP or TRP group is received. In this disclosure, at least one factor of the phase factor and the amplitude factor of the TRP or TRP group is incorporated into the combining coefficient matrix of the TRP or TRP group and reported to the network device, which may reduce a signaling overhead occupied by the network device when receiving the phase factor and the amplitude factor directly fed back by terminal device. Further, the network device may understand a TRP status of the terminal device, and then determine precoding for downlink transmission.

Please refer to FIG. 16, FIG. 16 is a flowchart illustrating a method for receiving a phase factor and an amplitude factor of a TRP or TRP group according to an embodiment of the present disclosure. The method for receiving a phase factor and an amplitude factor is performed by a network device. As illustrated in FIG. 16, the method may include, but is not limited to, following steps.

At step S1601, a quantized result corresponding to a sub-band amplitude factor and a sub-band phase factor sent by the terminal device is received in a sub-band manner.

In an embodiment of the present disclosure, the terminal device may determine a product of the sub-band amplitude factor and the sub-band phase factor, and obtain a third sub-band combining coefficient matrix by performing the multiplication operation on combining coefficients in the sub-band combining coefficient matrix of the TRP or TRP group by the product, and obtain a quantized result by compressing and quantizing the third sub-band combining coefficient matrix based on a frequency domain basis vector of the TRP or TRP group.

Optionally, the network device receives the quantized result corresponding to the sub-band amplitude factor and the sub-band phase factor sent by the terminal device in the sub-band manner. That is, the network device receives the sub-band amplitude factor and the sub-band phase factor of the TRP or TRP group in the sub-band manner.

In an embodiment of the present disclosure, at least one factor of the phase factor or the amplitude factor of the TRP or TRP group sent by the terminal device based on the combining coefficient matrix of the TRP or TRP group is received. In this disclosure, at least one factor of the phase factor and the amplitude factor of the TRP or TRP group is incorporated into the combining coefficient matrix of the TRP or TRP group and reported to the network device, which may reduce a signaling overhead occupied by the network device when receiving the phase factor and the amplitude factor directly fed back by terminal device. Further, the network device may understand a TRP status of the terminal device, and then determine precoding for downlink transmission.

In the present disclosure, the terminal device may independently quantize the phase factor and the amplitude factor of the TRP or TRP group. Correspondingly, the network device may receive an independent quantized result of at least one factor of the phase factor and the amplitude factor. Alternatively, the network device may receive a combined quantized result obtained by combining the independent quantized result of at least one factor of the phase factor and the amplitude factor with other parameters. Optionally, the other parameters may be reference amplitudes and/or differential coefficients in the combining coefficient matrix of the TRP or TRP group.

Regarding a process of independently quantizing the phase factor and the amplitude factor by the terminal device, please refer to the relevant content in the above embodiments, which will not be repeated here.

Regarding a process of the terminal device combining the independent quantized results of the phase factor and the amplitude factor with other parameters, please refer to the relevant content in the above embodiments, which will not be repeated here.

Optionally, the network device receives the independent quantized results of the phase factor and the amplitude factor sent by the terminal device in the wideband manner and/or the sub-band manner.

Optionally, in a case where the independent quantized results of the two factors are combined with other parameters, the network device may receive the combined quantized result sent by the terminal device in the wideband manner or the sub-band manner.

Optionally, in a case where the independent quantized result corresponding to a first factor in the phase factor and the amplitude factor is combined with other parameters, the network device may receive the combined quantized result sent by the terminal device in the wideband manner, and receive an independent quantization corresponding to a second factor of the phase factor and the amplitude factor sent by the terminal device in the sub-band manner. For example, the first factor may be the phase factor and the second factor may be the amplitude factor, or the first factor may be the amplitude factor and the second factor may be the phase factor.

It should be noted that a sum of normalized amplitude factors and normalized phase factors of all TRPs or TRP groups corresponding to the terminal device is 1. In an embodiment of the present disclosure, at least one TRP or TRP group without necessary to report the phase factor and/or the amplitude factor is present in all TRPs or TRP groups. Optionally, the network device may receive indication information sent by the terminal device, in which the indication information indicates a TRP or TRP group without necessary to report the phase factor and/or the amplitude factor. Optionally, the TRP or TRP group without necessary to report the phase factor and/or the amplitude factor may be configured by the network device for the terminal device. Correspondingly, the network device may configure the TRP or TRP group without necessary to report the phase factor and/or the amplitude factor for the terminal device through configuration information. For example, the TRP or TRP group without necessary to report the phase factor and/or the amplitude factor to the network device may be a TRP or TRP group that, the phase factor and/or amplitude factor may be 1 after normalization is completed for \tilde{W}₂.

In the above embodiments of the disclosure, the methods according to the embodiments of the disclosure are described from the perspectives of the network device and the terminal device, respectively. In order to realize each of functions in the methods according to the above embodiments of the disclosure, the network device and the terminal device may include a hardware structure, a software module, and realize each of the above functions in the form of hardware structure, software module, or a combination of hardware structure and software module. A certain function of the above functions may be performed in the form of hardware structure, software module, or a combination of hardware structure and software module.

As illustrated in FIG. 17, FIG. 17 is a schematic diagram illustrating a communication apparatus 170 according to an embodiment of the disclosure. The communication apparatus 170 illustrated in FIG. 17 may include a transceiver module 1701 and a processing module 1702. The transceiver module 1701 may include a transmitting module and/or a receiving module. The transmitting module is configured to perform a transmitting function, and the receiving module is configured to perform a receiving function, and the transceiver module 1701 may perform the transmitting function and/or the receiving function.

The communication apparatus 170 may be a terminal device, an apparatus in the terminal device, or an apparatus that can be used together with the terminal device. Alternatively, the communication apparatus 170 may be a network device, an apparatus in the network side device, or an apparatus that can be used together with the network device.

In a case that the communication apparatus 170 is the terminal device,
the transceiver module 1701 is configured to send at least one factor of the phase factor or the amplitude factor of the TRP or TRP group to a network device based on a combining coefficient matrix of the TRP or TRP group, in which, the TRP group includes at least one TRP.

Optionally, the processing module 1702 is further configured to perform a multiplication operation on the combining coefficient matrix by at least one factor of the phase factor or the amplitude factor, and quantize a multiplication operation result.

Optionally, the transceiver module 1701 is configured to send a quantized result to the network device.

Optionally, the transceiver module 1701 is configured to send a quantized result corresponding to at least one factor of the phase factor or the amplitude factor to the network device in a wideband manner and/or in a sub-band manner.

Optionally, the transceiver module 1701 is configured to send quantized results corresponding to the phase factor and the amplitude factor respectively to the network device in the wideband manner.

Optionally, the transceiver module 1701 is configured to send a quantized result corresponding to a first factor in the phase factor and the amplitude factor to the network device in the wideband manner; and
send a quantized result corresponding to a second factor in the phase factor and the amplitude factor to the network device in the sub-band manner.

Optionally, the transceiver module 1701 is configured to send quantized results corresponding to the phase factor and the amplitude factor respectively to the network device in the sub-band manner.

Optionally, the processing module 1702 is further configured to determine a product of the phase factor and the amplitude factor, and performing a multiplication operation on combining coefficients in the combining coefficient matrix by the product, and quantize a multiplication operation result.

Optionally, the processing module 1702 is further configured to perform a multiplication operation on reference amplitudes in the combining coefficient matrix by the amplitude factor, and quantize a multiplication operation result.

Optionally, the processing module 1702 is further configured to perform a multiplication operation on differential coefficients in the combining coefficient matrix by the phase factor, and quantize a multiplication operation result.

Optionally, the processing module 1702 is further configured to perform a multiplication operation on reference amplitudes in the combining coefficient matrix by the amplitude factor, and quantize a multiplication operation result; and quantize the phase factor and differential coefficients in the combining coefficient matrix independently.

Optionally, the processing module 1702 is further configured to perform a multiplication operation on differential coefficients in the combining coefficient matrix by the phase factor, and quantize a multiplication operation result; and quantize the amplitude factor independently.

Optionally, in a case that the first factor is the amplitude factor and the second factor is the phase factor, the phase factor includes a wideband phase factor and a sub-band phase factor; the processing module 1702 is further configured to perform a multiplication operation on the combining coefficient matrix by the amplitude factor and the wideband phase factor and quantize a multiplication operation result, and independently quantize the sub-band phase factor.

Optionally, the transceiver module 1701 is configured to send a quantized result corresponding to the amplitude factor and a quantized result corresponding to the wideband phase factor to the network device in the wideband manner, and send a quantized result corresponding to the sub-band phase factor to the network device in the sub-band manner; or send a quantized result corresponding to the amplitude factor to the network device in the wideband manner, and send a quantized result corresponding to the phase factor to the network device in the sub-band manner.

Optionally, the processing module 1702 is further configured to: determine a sub-band combining coefficient matrix corresponding to the TRP group for the sub-band phase factor; obtain a first sub-band combining coefficient matrix by multiplying the sub-band phase factor by the sub-band combining coefficient matrix; compress and quantize the first sub-band combining coefficient matrix based on a frequency domain basis vector of the TRP or TRP group.

Optionally, in a case that the first factor is the phase factor and the second factor is the amplitude factor, the amplitude factor includes a wideband amplitude factor and a sub-band amplitude factor; the processing module 1702 is further configured to perform a multiplication operation on the combining coefficient matrix by the phase factor and the wideband amplitude factor and quantize a multiplication operation result, and independently quantize the sub-band amplitude factor.

Optionally, the transceiver module 1701 is configured to: send a quantized result corresponding to the phase factor and a quantized result corresponding to the wideband amplitude factor to the network device in the wideband manner, and send a quantized result corresponding to the sub-band phase factor to the network device in the sub-band manner; or send a quantized result corresponding to the phase factor to the network device in the wideband manner, and send a quantized result corresponding to the amplitude factor to the network device in the sub-band manner.

Optionally, the processing module 1702 is further configured to:
determine a sub-band combining coefficient matrix corresponding to the TRP group for the sub-band amplitude factor;
obtain a second sub-band combining coefficient matrix by multiplying the sub-band amplitude factor by the sub-band combining coefficient matrix;
compress and quantize the second sub-band combining coefficient matrix based on a frequency domain basis vector of the TRP or TRP group.

Optionally, the processing module 1702 is further configured to: obtain a third sub-band combining coefficient matrix by performing a multiplication operation on a sub-band combining coefficient matrix of the TRP or TRP group by a sub-band amplitude factor and a sub-band phase factor; compress and quantize the third sub-band combining coefficient matrix based on a frequency domain basis vector of the TRP or TRP group.

Optionally, at least one TRP or TRP group without necessary to report the phase factor and/or the amplitude factor is present in all TRPs or TRP groups of the terminal device.

Optionally, the transceiver module 1701 is configured to send indication information to the network device, wherein the indication information indicates the TRP or TRP group without necessary to report the phase factor and/or the amplitude factor.

Optionally, the TRP or TRP group without necessary to report the phase factor and/or the amplitude factor is configured by the network device or predefined.

In a case that the communication apparatus 170 is the network device,
the transceiver module 1701 is configured to receive at least one factor of the phase factor or the amplitude factor of the TRP or TRP group that is sent by a terminal device based on a combining coefficient matrix of the TRP or TRP group, in which, the TRP group includes at least one TRP.

Optionally, the transceiver module 1701 is configured to receive a quantized result sent by the terminal device, in which, the quantized result is obtained by performing a multiplication operation on the combining coefficient matrix by at least one factor of the phase factor or the amplitude factor and quantizing a multiplication operation result.

Optionally, the transceiver module 1701 is configured to receive a quantized result corresponding to at least one factor of the phase factor or the amplitude factor sent by the terminal device in a wideband manner and/or in a sub-band manner.

Optionally, the transceiver module 1701 is configured to receive a quantized result corresponding to the phase factor sent by the terminal device in the wideband manner; and receive a quantized result corresponding to the amplitude factor sent by the terminal device in the wideband manner.

Optionally, the transceiver module 1701 is configured to receive a quantized result corresponding to a first factor in the phase factor and the amplitude factor sent by the terminal device in the wideband manner; and receive a quantized result corresponding to a second factor in the phase factor and the amplitude factor sent by the terminal device in the sub-band manner.

Optionally, the transceiver module 1701 is configured to receive a quantized result corresponding to the phase factor sent by the terminal device in the sub-band manner; and receive a quantized result corresponding to the amplitude factor sent by the terminal device in the sub-band manner.

Optionally, the processing module 1702 is configured to determine the phase factor and the amplitude factor according to the quantized result.

Optionally, in a case that the first factor is the amplitude factor and the second factor is the phase factor, the phase factor includes a wideband phase factor and a sub-band phase factor; the transceiver module 1701 is configured to receive a quantized result corresponding to the amplitude factor and a quantized result corresponding to the wideband phase factor sent by the terminal device in the wideband manner, and receive a quantized result corresponding to the sub-band phase factor sent by the terminal device in the sub-band manner; or receive a quantized result corresponding to the amplitude factor sent by the terminal device in the wideband manner, and receive a quantized result corresponding to the phase factor sent by the terminal device in the sub-band manner.

Optionally, the quantized result corresponding to the sub-band phase factor is obtained by multiplying the sub-band phase factor by the sub-band combining coefficient matrix of the TRP or TRP group, and compressing and quantizing a multiplication operation result based on a frequency domain basis vector of the TRP or TRP group.

In a case that the first factor is the phase factor and the second factor is the amplitude factor, the amplitude factor comprises a wideband amplitude factor and a sub-band amplitude factor; the transceiver module 1701 is configured to receive a quantized result corresponding to the phase factor and a quantized result corresponding to the wideband amplitude factor sent by the terminal device in the wideband manner, and receive a quantized result corresponding to the sub-band amplitude factor sent by the terminal device in the sub-band manner; or receive a quantized result corresponding to the phase factor sent by the terminal device in the wideband manner, and receive a quantized result corresponding to the amplitude factor sent by the terminal device in the sub-band manner.

Optionally, the quantized result corresponding to the sub-band amplitude factor is obtained by multiplying the sub-band amplitude factor by the sub-band combining coefficient matrix of the TRP or TRP group, and compressing and quantizing a multiplication operation result based on a frequency domain basis vector of the TRP or TRP group.

Optionally, the transceiver module 1701 is configured to receive a quantized result corresponding to a sub-band amplitude factor and a sub-band phase factor sent by the terminal device in the sub-band manner, in which, the quantized result corresponding to the sub-band amplitude factor and the sub-band phase factor is a quantized result obtained by performing a multiplication operation on a sub-band combining coefficient matrix of the TRP or TRP group by the sub-band amplitude factor and the sub-band phase factor and compressing and quantizing a multiplication operation result based on a frequency domain basis vector of the TRP or TRP group.

Optionally, the transceiver module 1701 is configured to receive indication information sent by the terminal device, in which, the indication information indicates a TRP or TRP group without necessary to report the phase factor and/or the amplitude factor.

Optionally, the transceiver module 1701 is configured to configure the TRP or TRP group without necessary to report the phase factor and/or the amplitude factor for the terminal device.

In an embodiment of the present disclosure, at least one factor of the phase factor or the amplitude factor of the TRP or TRP group is sent to the network device based on the combining coefficient matrix of the TRP or TRP group. At least one factor of the phase factor or the amplitude factor of the TRP or TRP group may be incorporated into the combining coefficient matrix of the TRP or TRP group and is sent to the network device, which may reduce a signaling overhead occupied when a terminal device directly feeds back the phase factor and amplitude factor to the network device. Furthermore, the present disclosure may cause the network device to understand a TRP status of the terminal device, and then determine downlink transmission precoding. As illustrated in FIG. 18, FIG. 18 is a schematic diagram of another communication apparatus 180 provided by an embodiment of the disclosure. The communication apparatus 180 may be a network device, a terminal device (such as a first terminal device in the foregoing method embodiment), or a chip, a chip system, or a processor that supports the network device to implement the above method, or may be a chip, a chip system, or a processor that supports the terminal device to implement the above method. The apparatus may be used to implement the method as described in the above method embodiments. For details, please refer to the description in the above method embodiment.

The communication apparatus 180 may include one or more processors 1801. The processor 1801 may be a general purpose processor or a dedicated processor, such as, a baseband processor or a central processor. The baseband processor is used for processing communication protocols and communication data. The central processor is used for controlling the communication apparatus (e.g., base station, baseband chip, terminal device, terminal device chip, DU, or CU), executing computer programs, and processing data of the computer programs.

Optionally, the communication apparatus 180 may include one or more memories 1802 on which a computer program 1803 may be stored. The processor 1801 executes the computer program 1803 to cause the communication apparatus 180 to perform the method described in the above method embodiments. Optionally, data may also be stored in the memory 1802. The communication apparatus 180 and the memory 1802 may be set separately or integrated together.

Optionally, the communication apparatus 180 may also include a transceiver 1804 and an antenna 1805. The transceiver 1804 may be referred to as a transceiver unit, a transceiver element, or a transceiver circuit, for implementing the transceiver function. The transceiver 1804 may include a receiver and a transmitter. The receiver may be referred to as a receiver element or a receiving circuit, for implementing the receiving function. The transmitter may be referred to as a transmitter element or a transmitting circuit, for implementing the transmitting function.

Optionally, the communication apparatus 180 may also include one or more interface circuits 1806. The interface circuits 1806 are used to receive code instructions and transmit them to the processor 1801. The processor 1801 runs the code instructions to cause the communication apparatus 180 to perform the method described in the method embodiments.

In an implementation, the processor 1801 may include a transceiver for implementing the receiving and transmitting functions. The transceiver may be, for example, a transceiver circuit, an interface, or an interface circuit. The transceiver circuit, interface, or interface circuit for implementing the receiving and transmitting functions may be separated or may be integrated together. The transceiver circuit, interface, or interface circuit described above may be used for code/data reading and writing, or may be used for signal transmission or delivery.

In an implementation, the processor 1801 may store a computer program 1803. When the processor 1801 executes the computer program 1803, the communication apparatus 180 is caused to perform the method as described in the above method embodiments. The above computer program may be solidified in the processor 1801, in such case, the processor 1801 may be implemented by hardware.

In an implementation, the communication apparatus 180 may include circuits. The circuits may implement the sending, receiving or communicating function in the preceding method embodiments. The processor and transceiver described in this disclosure may be implemented on integrated circuits (ICs), analog ICs, radio frequency integrated circuits (RFICs), mixed signal ICs, application specific integrated circuits (ASICs), printed circuit boards (PCBs), and electronic devices. The processor and transceiver may also be produced using various IC process technologies, such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication apparatus in the above description of embodiments may be a network device or a terminal device (such as a first terminal device in the foregoing method embodiment), but the scope of the communication apparatus described in the disclosure is not limited thereto, and the structure of the communication apparatus may not be limited by FIG. 18.

The communication apparatus may be a stand-alone device or may be part of a larger device. For example, the described communication apparatus may be:
(1) a stand-alone IC, chip, chip system or subsystem;
(2) a set of ICs including one or more ICs, optionally, the set of ICs may also include storage components for storing data and computer programs;
(3) an ASIC, such as a modem;
(4) a module that may be embedded within other devices;
(5) a receiver, a terminal device, a smart terminal device, a cellular phone, a wireless device, a handheld machine, a mobile unit, an in-vehicle device, a network device, a cloud device, an artificial intelligence device, and the like; and
(6) others.

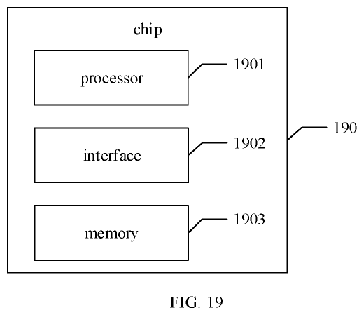

For a case where the communication apparatus may be a chip or a chip system, please refer to the schematic diagram of a chip shown in FIG. 19. In FIG. 19, the chip 190 includes a processor 1901 and an interface 1902. There may be one or more processors 1901, and there may be multiple interfaces 1902.

For a case where the chip is used to implement functions of the terminal device (such as the first terminal device in the aforementioned method embodiment) in an embodiment of the present disclosure,
the interface 1902 is configured to send at least one factor of the phase factor or the amplitude factor of the TRP or TRP group to a network device based on a combining coefficient matrix of the TRP or TRP group, in which, the TRP group includes at least one TRP.

Optionally, the processor 1901 is further configured to perform a multiplication operation on the combining coefficient matrix by at least one factor of the phase factor or the amplitude factor, and quantize a multiplication operation result.

Optionally, the interface 1902 is configured to send a quantized result to the network device.

Optionally, the interface 1902 is configured to send a quantized result corresponding to at least one factor of the phase factor or the amplitude factor to the network device in a wideband manner and/or in a sub-band manner.

Optionally, the interface 1902 is configured to send quantized results corresponding to the phase factor and the amplitude factor respectively to the network device in the wideband manner.

Optionally, the interface 1902 is configured to send a quantized result corresponding to a first factor in the phase factor and the amplitude factor to the network device in the wideband manner; and
send a quantized result corresponding to a second factor in the phase factor and the amplitude factor to the network device in the sub-band manner.

Optionally, the interface 1902 is configured to send quantized results corresponding to the phase factor and the amplitude factor respectively to the network device in the sub-band manner.

Optionally, the processor 1901 is further configured to determine a product of the phase factor and the amplitude factor, and performing a multiplication operation on combining coefficients in the combining coefficient matrix by the product, and quantize a multiplication operation result.

Optionally, the processor 1901 is further configured to perform a multiplication operation on reference amplitudes in the combining coefficient matrix by the amplitude factor, and quantize a multiplication operation result.

Optionally, the processor 1901 is further configured to perform a multiplication operation on differential coefficients in the combining coefficient matrix by the phase factor, and quantize a multiplication operation result.

Optionally, the processor 1901 is further configured to perform a multiplication operation on reference amplitudes in the combining coefficient matrix by the amplitude factor, and quantize a multiplication operation result; and quantize the phase factor and differential coefficients in the combining coefficient matrix independently.

Optionally, the processor 1901 is further configured to perform a multiplication operation on differential coefficients in the combining coefficient matrix by the phase factor, and quantize a multiplication operation result; and quantize the amplitude factor independently.

Optionally, in a case that the first factor is the amplitude factor and the second factor is the phase factor, the phase factor includes a wideband phase factor and a sub-band phase factor; the processor 1901 is further configured to perform a multiplication operation on the combining coefficient matrix by the amplitude factor and the wideband phase factor and quantize a multiplication operation result, and independently quantize the sub-band phase factor.

Optionally, the interface 1902 is configured to send a quantized result corresponding to the amplitude factor and a quantized result corresponding to the wideband phase factor to the network device in the wideband manner, and send a quantized result corresponding to the sub-band phase factor to the network device in the sub-band manner; or send a quantized result corresponding to the amplitude factor to the network device in the wideband manner, and send a quantized result corresponding to the phase factor to the network device in the sub-band manner.

Optionally, the processor 1901 is further configured to: determine a sub-band combining coefficient matrix corresponding to the TRP group for the sub-band phase factor; obtain a first sub-band combining coefficient matrix by multiplying the sub-band phase factor by the sub-band combining coefficient matrix; compress and quantize the first sub-band combining coefficient matrix based on a frequency domain basis vector of the TRP or TRP group.

Optionally, in a case that the first factor is the phase factor and the second factor is the amplitude factor, the amplitude factor includes a wideband amplitude factor and a sub-band amplitude factor; the processor 1901 is further configured to perform a multiplication operation on the combining coefficient matrix by the phase factor and the wideband amplitude factor and quantize a multiplication operation result, and independently quantize the sub-band amplitude factor.

Optionally, the interface 1902 is configured to: send a quantized result corresponding to the phase factor and a quantized result corresponding to the wideband amplitude factor to the network device in the wideband manner, and send a quantized result corresponding to the sub-band phase factor to the network device in the sub-band manner; or send a quantized result corresponding to the phase factor to the network device in the wideband manner, and send a quantized result corresponding to the amplitude factor to the network device in the sub-band manner.

Optionally, the processor 1901 is further configured to:
determine a sub-band combining coefficient matrix corresponding to the TRP group for the sub-band amplitude factor;
obtain a second sub-band combining coefficient matrix by multiplying the sub-band amplitude factor by the sub-band combining coefficient matrix;
compress and quantize the second sub-band combining coefficient matrix based on a frequency domain basis vector of the TRP or TRP group.

Optionally, the processor 1901 is further configured to: obtain a third sub-band combining coefficient matrix by performing a multiplication operation on a sub-band combining coefficient matrix of the TRP or TRP group by a sub-band amplitude factor and a sub-band phase factor; compress and quantize the third sub-band combining coefficient matrix based on a frequency domain basis vector of the TRP or TRP group.

Optionally, at least one TRP or TRP group without necessary to report the phase factor and/or the amplitude factor is present in all TRPs or TRP groups of the terminal device.

Optionally, the interface 1902 is configured to send indication information to the network device, wherein the indication information indicates the TRP or TRP group without necessary to report the phase factor and/or the amplitude factor.

Optionally, the TRP or TRP group without necessary to report the phase factor and/or the amplitude factor is configured by the network device or predefined.

For a case where a chip is configured to implement functions of the network device in an embodiment of the present disclosure:
the interface 1902 is configured to receive at least one factor of the phase factor or the amplitude factor of the TRP or TRP group that is sent by a terminal device based on a combining coefficient matrix of the TRP or TRP group, in which, the TRP group includes at least one TRP.

Optionally, the interface 1902 is configured to receive a quantized result sent by the terminal device, in which, the quantized result is obtained by performing a multiplication operation on the combining coefficient matrix by at least one factor of the phase factor or the amplitude factor and quantizing a multiplication operation result.

Optionally, the interface 1902 is configured to receive a quantized result corresponding to at least one factor of the phase factor or the amplitude factor sent by the terminal device in a wideband manner and/or in a sub-band manner.

Optionally, the interface 1902 is configured to receive a quantized result corresponding to the phase factor sent by the terminal device in the wideband manner; and receive a quantized result corresponding to the amplitude factor sent by the terminal device in the wideband manner.

Optionally, the interface 1902 is configured to receive a quantized result corresponding to a first factor in the phase factor and the amplitude factor sent by the terminal device in the wideband manner; and receive a quantized result corresponding to a second factor in the phase factor and the amplitude factor sent by the terminal device in the sub-band manner.

Optionally, the interface 1902 is configured to receive a quantized result corresponding to the phase factor sent by the terminal device in the sub-band manner; and receive a quantized result corresponding to the amplitude factor sent by the terminal device in the sub-band manner.

Optionally, the processor 1901 is configured to determine the phase factor and the amplitude factor according to the quantized result.

Optionally, in a case that the first factor is the amplitude factor and the second factor is the phase factor, the phase factor includes a wideband phase factor and a sub-band phase factor; the interface 1902 is configured to receive a quantized result corresponding to the amplitude factor and a quantized result corresponding to the wideband phase factor sent by the terminal device in the wideband manner, and receive a quantized result corresponding to the sub-band phase factor sent by the terminal device in the sub-band manner; or receive a quantized result corresponding to the amplitude factor sent by the terminal device in the wideband manner, and receive a quantized result corresponding to the phase factor sent by the terminal device in the sub-band manner.

Optionally, the quantized result corresponding to the sub-band phase factor is obtained by multiplying the sub-band phase factor by the sub-band combining coefficient matrix of the TRP or TRP group, and compressing and quantizing a multiplication operation result based on a frequency domain basis vector of the TRP or TRP group.

In a case that the first factor is the phase factor and the second factor is the amplitude factor, the amplitude factor comprises a wideband amplitude factor and a sub-band amplitude factor; the interface 1902 is configured to receive a quantized result corresponding to the phase factor and a quantized result corresponding to the wideband amplitude factor sent by the terminal device in the wideband manner, and receive a quantized result corresponding to the sub-band amplitude factor sent by the terminal device in the sub-band manner; or receive a quantized result corresponding to the phase factor sent by the terminal device in the wideband manner, and receive a quantized result corresponding to the amplitude factor sent by the terminal device in the sub-band manner.

Optionally, the quantized result corresponding to the sub-band amplitude factor is obtained by multiplying the sub-band amplitude factor by the sub-band combining coefficient matrix of the TRP or TRP group, and compressing and quantizing a multiplication operation result based on a frequency domain basis vector of the TRP or TRP group.

Optionally, the interface 1902 is configured to receive a quantized result corresponding to a sub-band amplitude factor and a sub-band phase factor sent by the terminal device in the sub-band manner, in which, the quantized result corresponding to the sub-band amplitude factor and the sub-band phase factor is a quantized result obtained by performing a multiplication operation on a sub-band combining coefficient matrix of the TRP or TRP group by the sub-band amplitude factor and the sub-band phase factor and compressing and quantizing a multiplication operation result based on a frequency domain basis vector of the TRP or TRP group.

Optionally, the interface 1902 is configured to receive indication information sent by the terminal device, in which, the indication information indicates a TRP or TRP group without necessary to report the phase factor and/or the amplitude factor.

Optionally, the interface 1902 is configured to configure the TRP or TRP group without necessary to report the phase factor and/or the amplitude factor for the terminal device.

Optionally, the chip 190 further includes a memory 1903 used for storing necessary computer programs and data.

In an embodiment of the present disclosure, at least one factor of the phase factor or the amplitude factor of the TRP or TRP group is sent to the network device based on the combining coefficient matrix of the TRP or TRP group. At least one factor of the phase factor or the amplitude factor of the TRP or TRP group may be incorporated into the combining coefficient matrix of the TRP or TRP group and is sent to the network device, which may reduce a signaling overhead occupied when a terminal device directly feeds back the phase factor and amplitude factor to the network device. Furthermore, the present disclosure may cause the network device to understand a TRP status of the terminal device, and then determine downlink transmission precoding.

It is understandable by those skilled in the art that various illustrative logical blocks and steps listed in the embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be construed as being beyond the scope of protection of the embodiments of the disclosure.

An embodiment of the disclosure also provides a communication system. The system includes a communication apparatus as a terminal device and a communication apparatus as a network side device in the aforementioned embodiment of FIG. 17, or the system includes a communication apparatus as a terminal device and a communication apparatus as a network side device in the aforementioned embodiment of FIG. 18.

The disclosure also provides a readable storage medium having instructions stored thereon. When the instructions are executed by a computer, the function of any of the method embodiments described above is implemented.

The disclosure also provides a computer program product. When the computer program product is executed by a computer, the function of any of the method embodiments described above is implemented.

The above embodiments may be implemented in whole or in part by software, hardware, firmware, or any combination thereof. When implemented using software, it may be implemented, in whole or in part, in the form of a computer program product. The computer program product includes one or more computer programs. When loading and executing the computer programs on the computer, all or part of processes or functions described in the embodiments of the disclosure are implemented. The computer may be a general-purpose computer, a dedicated computer, a computer network, or other programmable devices. The computer program may be stored in a computer-readable storage medium or transmitted from one computer-readable storage medium to another computer-readable storage medium. For example, the computer program may be transmitted from one web site, computer, server, or data center to another web site, computer, server, or data center, in a wired manner (e.g., by using coaxial cables, fiber optics, or digital subscriber lines (DSLs) or wirelessly (e.g., by using infrared wave, wireless wave, or microwave). The computer-readable storage medium may be any usable medium to which the computer has access or a data storage device such as a server and a data center integrated by one or more usable mediums. The usable medium may be a magnetic medium (e.g., floppy disk, hard disk, and tape), an optical medium (e.g., a high-density digital video disc (DVD)), or a semiconductor medium (e.g., a solid state disk (SSD)).

Those skilled in the art understand that “first”, “second”, and other various numerical numbers involved in the disclosure are only described for the convenience of differentiation, and are not used to limit the scope of the embodiments of the disclosure, or indicate the order of precedence.

The term “at least one” in the disclosure may also be described as one or more, and the term “multiple” may be two, three, four, or more, which is not limited in the disclosure. In the embodiments of the disclosure, for a type of technical features, “first”, “second”, and “third”, and “A”, “B”, “C” and “D” are used to distinguish different technical features of the type, the technical features described using the “first”, “second”, and “third”, and “A”, “B”, “C” and “D” do not indicate any order of precedence or magnitude.

The correspondences shown in the tables in this disclosure may be configured or may be predefined. The values of information in the tables are merely examples and may be configured to other values, which are not limited by the disclosure. In configuring the correspondence between the information and the parameter, it is not necessarily required that all the correspondences illustrated in the tables must be configured. For example, the correspondences illustrated in certain rows in the tables in this disclosure may not be configured. For another example, the above tables may be adjusted appropriately, such as splitting, combining, and the like. The names of the parameters shown in the titles of the above tables may be other names that can be understood by the communication device, and the values or representations of the parameters may be other values or representations that can be understood by the communication device. Each of the above tables may also be implemented with other data structures, such as, arrays, queues, containers, stacks, linear tables, pointers, chained lists, trees, graphs, structures, classes, heaps, and Hash tables.

The term “predefine” in this disclosure may be understood as define, pre-define, store, pre-store, pre-negotiate, pre-configure, solidify, or pre-fire.

Those skilled in the art may realize that the units and algorithmic steps of the various examples described in combination with the embodiments disclosed herein are capable of being implemented in the form of electronic hardware, or a combination of computer software and electronic hardware. Whether these functions are performed in the form of hardware or software depends on the specific application and design constraints of the technical solution. Those skilled in the art may use different methods to implement the described functions for each particular application, but such implementations should not be considered as beyond the scope of the disclosure.

It is clearly understood by those skilled in the field to which it belongs that, for the convenience and brevity of description, the specific working processes of the systems, apparatuses, and units described above may be referred to the corresponding processes in the preceding method embodiments, and will not be repeated herein.

The above implementations are only specific implementations of the disclosure, but the scope of protection of the disclosure is not limited thereto. Those skilled in the art familiar to this technical field can easily think of changes or substitutions in the technical scope disclosed by the disclosure, which shall be covered by the scope of protection of the disclosure. Therefore, the scope of protection of the disclosure shall be governed by the scope of protection of the stated claims.

1. A method for sending a phase factor and an amplitude factor of a transmission reception point (TRP) or TRP group, performed by a terminal device, comprising:
sending at least one factor of the phase factor or the amplitude factor of the TRP or TRP group to a network device based on a combining coefficient matrix of the TRP or TRP group, wherein the TRP group comprises at least one TRP.

2. The method according to claim 1, wherein sending at least one factor of the phase factor or the amplitude factor of the TRP or TRP group to the network device based on the combining coefficient matrix of the TRP or TRP group comprises:
performing a multiplication operation on the combining coefficient matrix by at least one factor of the phase factor or the amplitude factor, and quantizing a multiplication operation result;
sending a quantized result to the network device.

3. The method according to claim 2, wherein sending the quantized result to the network device comprises:
sending a quantized result corresponding to at least one factor of the phase factor or the amplitude factor to the network device in a wideband manner and/or in a sub-band manner.

4. The method according to claim 3, further comprising at least one of:
sending quantized results corresponding to the phase factor and the amplitude factor respectively to the network device in the wideband manner,
sending a quantized result corresponding to a first factor in the phase factor and the amplitude factor to the network device in the wideband manner, and sending a quantized result corresponding to a second factor in the phase factor and the amplitude factor to the network device in the sub-band manner; or
sending quantized results corresponding to the phase factor and the amplitude factor respectively to the network device in the sub-band manner.

5-6. (canceled)

7. The method according to claim 2, further comprising at least one of:
determining a product of the phase factor and the amplitude factor, and performing a multiplication operation on combining coefficients in the combining coefficient matrix by the product, and quantizing a multiplication operation result;
performing a multiplication operation on reference amplitudes in the combining coefficient matrix by the amplitude factor, and quantizing a multiplication operation result, and performing a multiplication operation on differential coefficients in the combining coefficient matrix by the phase factor, and quantizing a multiplication operation result;
performing a multiplication operation on reference amplitudes in the combining coefficient matrix by the amplitude factor, and quantizing a multiplication operation result, and quantizing the phase factor and differential coefficients in the combining coefficient matrix independently; or
performing a multiplication operation on differential coefficients in the combining coefficient matrix by the phase factor, and quantizing a multiplication operation result, and quantizing the amplitude factor independently.

8-9. (canceled)

10. The method according to claim 4, wherein in a case that the first factor is the amplitude factor and the second factor is the phase factor, the phase factor comprises a wideband phase factor and a sub-band phase factor;
wherein performing the multiplication operation on the combining coefficient matrix by at least one factor of the phase factor or the amplitude factor and quantizing the multiplication operation result comprises:
performing a multiplication operation on the combining coefficient matrix by the amplitude factor and the wideband phase factor and quantizing a multiplication operation result, and independently quantizing the sub-band phase factor;
wherein sending the quantized result to the network device in the wideband manner and/or in the sub-band manner comprises:
sending a quantized result corresponding to the amplitude factor and a quantized result corresponding to the wideband phase factor to the network device in the wideband manner, and sending a quantized result corresponding to the sub-band phase factor to the network device in the sub-band manner; or
sending a quantized result corresponding to the amplitude factor to the network device in the wideband manner, and sending a quantized result corresponding to the phase factor to the network device in the sub-band manner;
wherein the method further comprises:
determining a sub-band combining coefficient matrix corresponding to the TRP group for the sub-band phase factor;
obtaining a first sub-band combining coefficient matrix by multiplying the sub-band phase factor by the sub-band combining coefficient matrix; and
compressing and quantizing the first sub-band combining coefficient matrix based on a frequency domain basis vector of the TRP or TRP group.

11. (canceled)

12. The method according to claim 4, wherein, in a case that the first factor is the phase factor and the second factor is the amplitude factor, the amplitude factor comprises a wideband amplitude factor and a sub-band amplitude factor;
wherein performing the multiplication operation on the combining coefficient matrix by at least one factor of the phase factor or the amplitude factor and quantizing the multiplication operation result comprises:
performing a multiplication operation on the combining coefficient matrix by the phase factor and the wideband amplitude factor and quantizing a multiplication operation result, and independently quantizing the sub-band amplitude factor;
wherein sending the quantized result to the network device in the wideband manner and/or in the sub-band manner comprises:
sending a quantized result corresponding to the phase factor and a quantized result corresponding to the wideband amplitude factor to the network device in the wideband manner, and sending a quantized result corresponding to the sub-band amplitude factor to the network device in the sub-band manner; or
sending a quantized result corresponding to the phase factor to the network device in the wideband manner, and sending a quantized result corresponding to the amplitude factor to the network device in the sub-band manner;
wherein the method further comprises:
determining a sub-band combining coefficient matrix corresponding to the TRP group for the sub-band amplitude factor;
obtaining a second sub-band combining coefficient matrix by multiplying the sub-band amplitude factor by the sub-band combining coefficient matrix; and
compressing and quantizing the second sub-band combining coefficient matrix based on a frequency domain basis vector of the TRP or TRP group.

13. (canceled)

14. The method according to claim 4, wherein performing the multiplication operation on the combining coefficient matrix by at least one factor of the phase factor or the amplitude factor and quantizing the multiplication operation result comprises:
obtaining a third sub-band combining coefficient matrix by performing a multiplication operation on a sub-band combining coefficient matrix of the TRP or TRP group by a sub-band amplitude factor and a sub-band phase factor; and
compressing and quantizing the third sub-band combining coefficient matrix based on a frequency domain basis vector of the TRP or TRP group.

15. The method according to claim 1, wherein at least one TRP or TRP group without necessary to report the phase factor and/or the amplitude factor is present in all TRPs or TRP groups of the terminal device:
wherein the method further comprises:
sending indication information to the network device, wherein the indication information indicates the TRP or TRP group without necessary to report the phase factor and/or the amplitude factor; or the TRP or TRP group without necessary to report the phase factor and/or the amplitude factor is configured by the network device or predefined.

16. The method according to claim 15, wherein
the method further comprises: sending indication information to the network device, wherein the indication information indicates the TRP or TRP group without necessary to report the phase factor and/or the amplitude factor; or
the TRP or TRP group without necessary to report the phase factor and/or the amplitude factor is configured by the network device or predefined.

17. A method for receiving a phase factor and an amplitude factor of a transmission reception point (TRP) or TRP group, performed by a network device, comprising:
receiving at least one factor of the phase factor or the amplitude factor of the TRP or TRP group that is sent by a terminal device based on a combining coefficient matrix of the TRP or TRP group, wherein the TRP group comprises at least one TRP.

18. The method according to claim 17, wherein receiving at least one factor of the phase factor or the amplitude factor of the TRP or TRP group that is sent by the terminal device based on the combining coefficient matrix of the TRP or TRP group comprises:
receiving a quantized result sent by the terminal device, wherein the quantized result is obtained by performing a multiplication operation on the combining coefficient matrix by at least one factor of the phase factor or the amplitude factor and quantizing a multiplication operation result.

19. The method according to claim 18, wherein receiving the quantized result sent by the terminal device comprises:
receiving a quantized result corresponding to at least one factor of the phase factor or the amplitude factor sent by the terminal device in a wideband manner and/or in a sub-band manner.

20. The method according to claim 19, further comprising at least one of:
receiving a quantized result corresponding to the phase factor sent by the terminal device in the wideband manner, and
receiving a quantized result corresponding to the amplitude factor sent by the terminal device in the wideband manner; or
receiving a quantized result corresponding to a first factor in the phase factor and the amplitude factor sent by the terminal device in the wideband manner, and receiving a quantized result corresponding to a second factor in the phase factor and the amplitude factor sent by the terminal device in the sub-band manner; or
receiving a quantized result corresponding to the phase factor sent by the terminal device in the sub-band manner, and receiving a quantized result corresponding to the amplitude factor sent by the terminal device in the sub-band manner.

21-22. (canceled)

23. The method according to claim 18, further comprising:
determining the phase factor and the amplitude factor according to the quantized result.

24. The method according to claim 21, wherein in a case that the first factor is the amplitude factor and the second factor is the phase factor, the phase factor comprises a wideband phase factor and a sub-band phase factor;
wherein the method further comprises:
receiving a quantized result corresponding to the amplitude factor and a quantized result corresponding to the wideband phase factor sent by the terminal device in the wideband manner, and receiving a quantized result corresponding to the sub-band phase factor sent by the terminal device in the sub-band manner; or
receiving a quantized result corresponding to the amplitude factor sent by the terminal device in the wideband manner, and receiving a quantized result corresponding to the phase factor sent by the terminal device in the sub-band manner;
wherein the quantized result corresponding to the sub-band phase factor is obtained by multiplying the sub-band phase factor by the sub-band combining coefficient matrix of the TRP or TRP group, and compressing and quantizing a multiplication operation result based on a frequency domain basis vector of the TRP or TRP group.

25. (canceled)

26. The method according to claim 21, wherein, in a case that the first factor is the phase factor and the second factor is the amplitude factor, the amplitude factor comprises a wideband amplitude factor and a sub-band amplitude factor;
wherein the method further comprises:
receiving a quantized result corresponding to the phase factor and a quantized result corresponding to the wideband amplitude factor sent by the terminal device in the wideband manner, and receiving a quantized result corresponding to the sub-band amplitude factor sent by the terminal device in the sub-band manner; or
receiving a quantized result corresponding to the phase factor sent by the terminal device in the wideband manner, and receiving a quantized result corresponding to the amplitude factor sent by the terminal device in the sub-band manner;
wherein the quantized result corresponding to the sub-band amplitude factor is obtained by multiplying the sub-band amplitude factor by the sub-band combining coefficient matrix of the TRP or TRP group, and compressing and quantizing a multiplication operation result based on a frequency domain basis vector of the TRP or TRP group.

27. (canceled)

28. The method according to claim 20, wherein receiving the quantized result sent by the terminal device comprises:
receiving a quantized result corresponding to a sub-band amplitude factor and a sub-band phase factor sent by the terminal device in the sub-band manner, wherein the quantized result corresponding to the sub-band amplitude factor and the sub-band phase factor is a quantized result obtained by performing a multiplication operation on a sub-band combining coefficient matrix of the TRP or TRP group by the sub-band amplitude factor and the sub-band phase factor and compressing and quantizing a multiplication operation result based on a frequency domain basis vector of the TRP or TRP group.

29. The method according to claim 17, further comprising:
receiving indication information sent by the terminal device, wherein the indication information indicates a TRP or TRP group without necessary to report the phase factor and/or the amplitude factor; or
configuring the TRP or TRP group without necessary to report the phase factor and/or the amplitude factor for the terminal device.

30-31. (canceled)

32. A terminal device, comprising a processor and a memory having a computer program stored thereon, wherein the processor is configured to:
send at least one factor of the phase factor or the amplitude factor of the TRP or TRP group to a network device based on a combining coefficient matrix of the TRP or TRP group, wherein the TRP group comprises at least one TRP.

33. A network device configured to perform the method according to claim 17.

34-37. (canceled)
